(19) United States
(12) Patent Application Publication
(10) Pub. No.: US 2021/0034052 A1
(43) Pub. Date: Feb. 4, 2021

(54) INFORMATION PROCESSING DEVICE, INSTRUCTION METHOD FOR PROMPTING INFORMATION, PROGRAM, AND RECORDING MEDIUM

(71) Applicant: SZ DJI TECHNOLOGY CO., LTD., Shenzhen (CN)

(72) Inventors: Jiemin ZHOU, Shenzhen (CN); Ming SHAO, Shenzhen (CN); Hui XU, Shenzhen (CN)

(21) Appl. No.: 17/075,089

(22) Filed: Oct. 20, 2020

Related U.S. Application Data
(63) Continuation of application No. PCT/CN2019/083477, filed on Apr. 19, 2019.

(30) Foreign Application Priority Data
Apr. 27, 2018 (JP) 2018-086903

(51) Int. Cl. G05D 1/00; G05D 1/10; B64C 39/02

(52) U.S. Cl. CPC G05D 1/0033; G05D 1/1064; G05D 1/0094; B64C 2201/146; B64C 39/024; B64C 2201/127; G05D 1/104

(57) ABSTRACT

An information processing device includes a processor configured to obtain a first point of interest to which a first user pays attention in a first image and obtain a second point of interest to which a second user pays attention in a second image. The first image is shot by a first flight body controlled by a first terminal operated by the first user, and the second image is shot by a second flight body controlled by a second terminal operated by the second user. The processor is further configured to determine whether the first point of interest and the second point of interest are a common point of interest, and prompt information related to the second flight body to the first terminal in response to the first point of interest and the second point of interest being the common point of interest.

### CROSS-REFERENCE TO RELATED APPLICATIONS

This application is a continuation of International Application No. PCT/CN2019/083477, filed Apr. 19, 2019, which claims priority to Japanese Application No. 2018-086903, filed Apr. 27, 2018, the entire contents of both of which are incorporated herein by reference.

### TECHNICAL FIELD

The present disclosure relates to an information processing device, an instruction method for prompting information, a program, and a recording medium that prompt information according to a user's point of interest in an image shot by a flight body.

### BACKGROUND

In the past, users did not need to look at an unmanned aerial vehicle (UAV) during flying the UAV. For example, the user can operate in a first-person view (FPV), i.e., operating the UAV using a terminal while observing an image obtained by the UAV and displayed on the terminal's display.

Patent Document 1: Japanese Patent Application Publication No. 2016-203978.

When the UAV performs an FPV flight, it is difficult for the user to confirm the surrounding conditions of the UAV if the user only views the shot images. For example, in a scenario of multiple UAVs flying towards a same destination, as they approach the destination, the UAVs approach each other, and the UAVs may collide with each other.

### SUMMARY

In accordance with the disclosure, there is provided an information processing device including a processor configured to obtain a first point of interest to which a first user pays attention in a first image and obtain a second point of interest to which a second user pays attention in a second image. The first image is shot by a first flight body controlled by a first terminal operated by the first user, and the second image is shot by a second flight body controlled by a second terminal operated by the second user. The processor is further configured to determine whether the first point of interest and the second point of interest are a common point of interest, and prompt information related to the second flight body to the first terminal in response to the first point of interest and the second point of interest being the common point of interest.

Also in accordance with the disclosure, there is provided an information prompt method including obtaining a first point of interest to which a first user pays attention in a first image and obtaining a second point of interest to which a second user pays attention in a second image. The first image is shot by a first flight body controlled by a first terminal operated by the first user, and the second image is shot by a second flight body controlled by a second terminal operated by the second user. The method further includes determining whether the first point of interest and the second point of interest are a common point of interest, and prompting information related to the second flight body to the first terminal in response to the first point of interest and the second point of interest being the common point of interest.

Also in accordance with the disclosure, there is provided a non-transitory computer-readable recording medium storing a program that, when executed by a processor, causes the processor to obtain a first point of interest to which a first user pays attention in a first image and obtain a second point of interest to which a second user pays attention in a second image. The first image is shot by a first flight body controlled by a first terminal operated by the first user, and the second image is shot by a second flight body controlled by a second terminal operated by the second user. The program further causes the processor to determine whether the first point of interest and the second point of interest are a common point of interest, and prompt information related to the second flight body to the first terminal in response to the first point of interest and the second point of interest being the common point of interest.

### BRIEF DESCRIPTION OF THE DRAWINGS

FIG. 1 is a schematic diagram of a flight system consistent with embodiments of the disclosure.

FIG. 2 is a diagram showing an unmanned aerial vehicle (UAV) consistent with embodiments of the disclosure.

FIG. 3 is a block diagram showing a hardware configuration of the UAV consistent with embodiments of the disclosure.

FIG. 4 is a perspective view of a terminal provided with a transmitter consistent with embodiments of the disclosure.

FIG. 5 is a block diagram showing a hardware configuration of the transmitter consistent with embodiments of the disclosure.

FIG. 6A is a block diagram showing a hardware configuration of the terminal consistent with embodiments of the disclosure.

FIG. 6B is a block diagram showing a hardware configuration of a server consistent with embodiments of the disclosure.

FIG. 7 is a sequence diagram of an instruction process for prompting information performed by a server consistent with embodiments of the disclosure.

FIG. 8 is a diagram showing detecting a point of interest consistent with embodiments of the disclosure.

FIG. 9A is a diagram showing shot images displayed on various displays when the points of interest of two users are a common point of interest.

FIG. 9B is a diagram showing shot images GZ1 and GZ2 displayed on the displays of various terminals when the points of interest of two users are not common points of interest.

FIG. 10 is a diagram showing a positional relationship between two UAVs consistent with embodiments of the disclosure.

FIG. 11A is a diagram showing an image shot by a UAV and displayed on a display of a terminal.

FIG. 11B is a diagram showing an image shot by a UAV and displayed on a display of another terminal.

FIG. 12A is a sequence diagram of an instruction process for prompting information from a viewpoint of the UAV performed by a server consistent with embodiments of the disclosure.

FIG. 12B is a sequence diagram of the instruction process for prompting information from the viewpoint of the UAV performed by the server following the process shown in FIG. 12A.

FIG. 13 is a spatial diagram showing threshold values D set for a distance between two UAVs.

FIG. 14A is a diagram showing a recommendation image displayed on the display when the distance is within a threshold.

FIG. 14B is a diagram showing a recommendation image displayed on the display when the distance is within a threshold.

FIG. 15A is a diagram showing a scenario where the UAV is operated with a visual observation.

FIG. 15B is a diagram showing a scenario where the UAV is operated with an FPV flight mode.

FIG. 16A is a sequence diagram of an instruction process for prompting information from a viewpoint of a destination performed by a server consistent with embodiments of the disclosure.

FIG. 16B is a sequence diagram of the instruction process for prompting information from the viewpoint of the destination performed by the server following FIG. 16A.

FIG. 17 is a sequence diagram of an instruction process for prompting information from a viewpoint of a UAV performed by a terminal consistent with embodiments of the disclosure.

FIG. 18A is a sequence diagram of an instruction process for prompting information from a viewpoint of a UAV performed by a terminal consistent with embodiments of the disclosure.

FIG. 18B is a sequence diagram of the instruction process for prompting information from the viewpoint of the UAV performed by the terminal following FIG. 18A.

FIG. 19 is a perspective view of a head-mounted display consistent with embodiments of the disclosure.

FIG. 20 is a block diagram showing a hardware configuration of the head-mounted display consistent with embodiments of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

In the following embodiments, an unmanned aerial vehicle (UAV) is described as an example of the flight body. The UAV includes an aircraft that can move in the air. In the accompanying drawings, the unmanned aerial vehicle is also marked as “UAV.” In addition, an information processing device is exemplified by a server, a terminal, or the like. An instruction method for prompting information specifies operations of the information processing device. In addition, a program (for example, a program that causes the information processing device to perform various processes) is recorded in a recording medium.

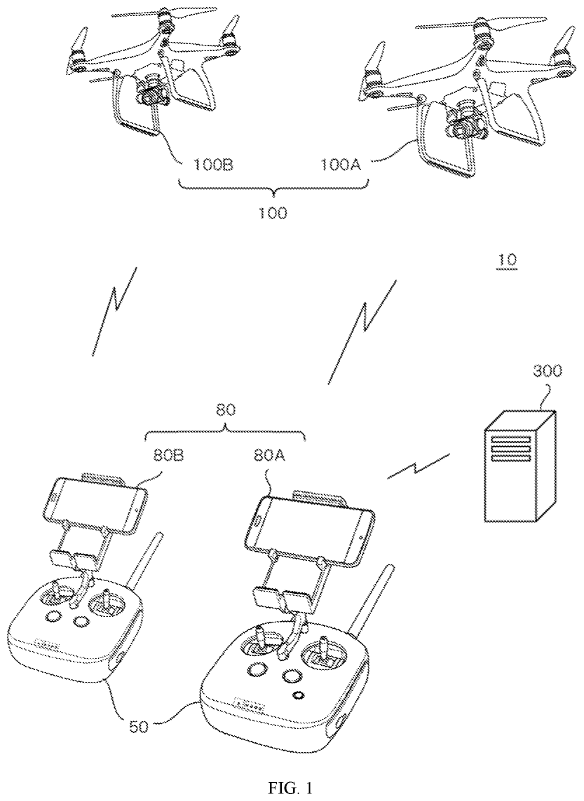

FIG. 1 is a schematic diagram of a flight system 10 according to an embodiment of the disclosure. The flight system 10 includes a plurality of UAVs 100, a transmitter 50, a plurality of terminals 80, and a server 300. The UAV 100, the transmitter 50, the terminal 80, and the server 300 may communicate with each other through a wired communication or a wireless communication (for example, a wireless local area network (LAN)). The terminal 80 may communicate with the server 300 through a wired communication or a wireless communication. In FIG. 1, as the plurality of UAVs 100, UAV 100A and UAV 100B are shown. As the plurality of terminals 80, terminal 80A and terminal 80B are shown.

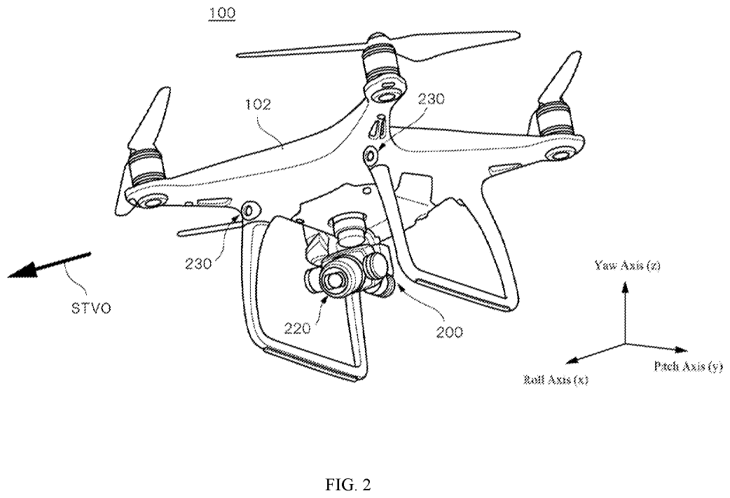

FIG. 2 is a diagram showing the UAV 100 according to an embodiment of the disclosure. FIG. 2 shows a perspective view of the UAV 100 flying in a direction STV0. The UAV 100 is an example of the flight body.

As shown in FIG. 2, a roll axis (x axis) is defined in a direction parallel to the ground and along the moving direction of STV0. Further, a pitch axis (y axis) is determined in a direction parallel to the ground and perpendicular to the roll axis, and a yaw axis (z axis) is determined in a direction perpendicular to the ground and perpendicular to the roll axis and the pitch axis.

The UAV 100 includes a UAV main body 102, a gimbal 200, a photographing device 220, and a plurality of photographing devices 230. The UAV main body 102 is an example of a casing of the UAV 100. The photographing devices 220 and 230 are examples of a photographing unit.

The UAV main body 102 includes a plurality of rotors (propellers). The UAV main body 102 causes the UAV 100 to fly by controlling rotations of the plurality of rotors. The UAV main body 102 uses, for example, four rotors to cause the UAV 100 to fly. The number of rotors is not limited to four. In addition, the UAV 100 may be a fixed-wing aircraft without rotors.

The photographing device 220 may be an imaging camera that shoots an object included in a desired shooting range (for example, the sky above a shot object, a scenery such as mountains and rivers, and a building on the ground).

The plurality of photographing devices 230 may be sensing cameras that shoot surroundings of the UAV 100 in order to control the flight of the UAV 100. The two photographing devices 230 may be provided at a nose, that is, the front of the UAV 100. Furthermore, the other two photographing devices 230 may be provided at a bottom surface of the UAV 100. The two photographing devices 230 on the front side may be paired to function as a stereo camera. The two photographing devices 230 on the bottom side may also be paired to function as a stereo camera system. Three-dimensional spatial data around the UAV 100 can be generated from images shot by the plurality of photographing devices 230. In addition, the number of photographing devices 230 included in the UAV 100 is not limited to four. The UAV 100 may include at least one photographing device 230. The UAV 100 may include at least one photographing device 230 at the nose, a tail, a side, a bottom surface, or a top surface of the UAV 100, respectively. An angle of view of the photographing device 230 may be greater than an angle of view of the photographing device 220. The photographing device 230 may have single a focus lens or a fisheye lens.

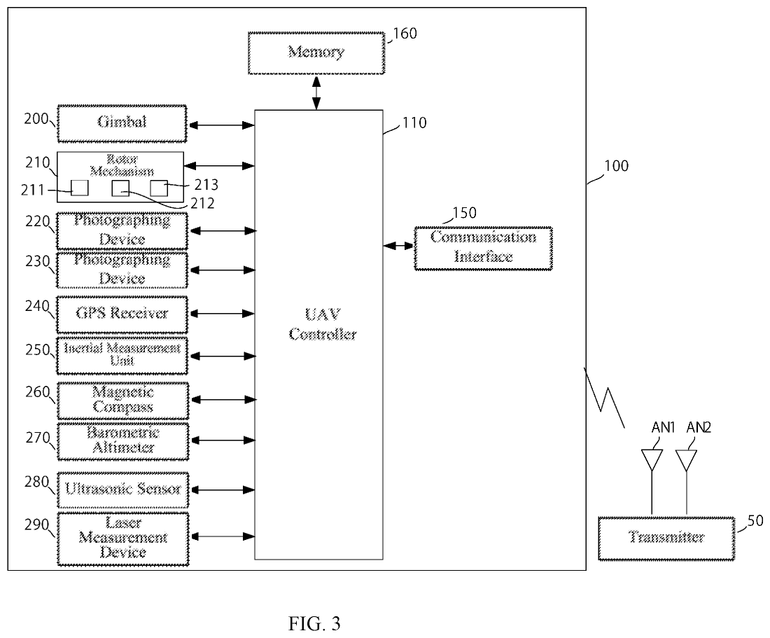

FIG. 3 is a block diagram showing a hardware configuration of the UAV 100 according to an embodiment. The UAV 100 includes a UAV controller 110, a communication interface 150, a memory 160, the gimbal 200, a rotor mechanism 210, the photographing device 220, the photographing device 230, a GPS receiver 240, an inertial measurement unit (IMU) 250, a magnetic compass 260, a barometric altimeter 270, an ultrasonic sensor 280, and a laser measurement device 290. The communication interface 150 is an example of a communication circuit.

The UAV controller 110 includes, for example, a processor, such as a central processing unit (CPU), a micro processing unit (MPU), and/or a digital signal processor (DSP). The UAV controller 110 performs signal processing for overall control of the operations of each part of the UAV 100, data input/output processing with other parts, data calculation processing, and data storage processing. The UAV controller 110 is an example of a processing circuit.

The UAV controller 110 controls the flight of the UAV 100 according to a program stored in the memory 160. The UAV controller 110 controls the flight of the UAV 100 according to instructions received from the remote transmitter 50 through the communication interface 150. The memory 160 can be detached from the UAV 100.

The UAV controller 110 can specify the surrounding environment of the UAV 100 by analyzing a plurality of images shot by the plurality of photographing devices 230. The UAV controller 110 controls the flight according to the surrounding environment of the UAV 100, for example, to avoid obstacles.

The UAV controller 110 obtains date information indicating a current date. The UAV controller 110 may obtain date information representing the current date from the GPS receiver 240. The UAV controller 110 may obtain date information indicating the current date from a timer (not shown in the figure) mounted at the UAV 100.

The UAV controller 110 obtains position information indicating a position of the UAV 100. The UAV controller 110 can obtain position information indicating a latitude, a longitude, and an altitude about where the UAV 100 is located from the GPS receiver 240. The UAV controller 110 may obtain position information including latitude and longitude information indicating the latitude and longitude of the UAV 100 from the GPS receiver 240, and altitude information indicating the altitude of the UAV 100 from the barometric altimeter 270. The UAV controller 110 may obtain a distance between an emission point of an ultrasonic wave generated by the ultrasonic sensor 280 and a reflection point of the ultrasonic wave as height information.

The UAV controller 110 obtains orientation information indicating an orientation of the UAV 100 from the magnetic compass 260. For example, the orientation information may indicate an orientation corresponding to the orientation of the nose of the UAV 100.

The UAV controller 110 may obtain position information indicating the position where the UAV 100 should locate when the photographing device 220 shoots in the shooting range. The UAV controller 110 can obtain position information indicating the position where the UAV 100 should locate from the memory 160. The UAV controller 110 can obtain position information indicating the position where the UAV 100 should locate from another device such as the transmitter 50 through the communication interface 150. The UAV controller 110 can refer to a three-dimensional map database to specify a position where the UAV 100 can locate in order to shoot in the shooting range, and obtain the position as the position information indicating the position where the UAV 100 should locate.

The UAV controller 110 obtains shooting information indicating the shooting ranges of the photographing device 220 and the photographing device 230, respectively. The UAV controller 110 obtains angle of view information indicating the angle of view of the photographing device 220 and the photographing device 230 from the photographing device 220 and the photographing device 230 as a parameter for specifying the shooting range. The UAV controller 110 obtains information indicating the shooting direction of the photographing device 220 and the photographing device 230 as a parameter for specifying the shooting range. The UAV controller 110 obtains attitude information indicating the attitude of the photographing device 220 from the gimbal 200 as information indicating the shooting direction of the photographing device 220, for example. The UAV controller 110 obtains information indicating the orientation of the UAV 100. The information indicating the attitude of the photographing device 220 indicates an angle at which the gimbal 200 is rotated from a reference rotation angle of the pitch axis and the yaw axis. The UAV controller 110 obtains position information indicating the position of the UAV 100 as a parameter for specifying the shooting range. The UAV controller 110 can generate shooting information representing the shooting range by delimiting the shooting range representing a geographic range shot by the photographing device 220 according to the angle of view and shooting direction of the photographing device 220 and the photographing device 230, and the position of the UAV 100, and further obtain the shooting information.

The UAV controller 110 can obtain shooting information indicating the shooting range to be shot by the photographing device 220. The UAV controller 110 can obtain the shooting information to be shot by the photographing device 220 from the memory 160. The UAV controller 110 can obtain the shooting information to be shot by the photographing device 220 from another device such as the transmitter 50 through the communication interface 150.

The UAV controller 110 can obtain three-dimensional information representing a three-dimensional shape of an object existing around the UAV 100. The object may be a part of a landscape such as a building, a road, a vehicle, or a tree, etc. The three-dimensional information may be, for example, three-dimensional spatial data. The UAV controller 110 can obtain the three-dimensional information from each image obtained by the plurality of photographing devices 230 by generating three-dimensional information indicating the three-dimensional shape of the object existing around the UAV 100. The UAV controller 110 can obtain the three-dimensional information indicating the three-dimensional shape of the object existing around the UAV 100 by referring to a three-dimensional map database stored in the memory 160. The UAV controller 110 can obtain three-dimensional information related to the three-dimensional shape of the object existing around the UAV 100 by referring to a three-dimensional map database managed by a server existing on the network.

The UAV controller 110 obtains image data shot by the photographing device 220 and the photographing device 230.

The UAV controller 110 controls the gimbal 200, the rotor mechanism 210, the photographing device 220, and the photographing device 230. The UAV controller 110 controls the shooting range of the photographing device 220 by changing the shooting direction or angle of view of the photographing device 220. The UAV control unit 110 controls the shooting range of the photographing device 220 supported by the gimbal 200 by controlling the rotation mechanism of the gimbal 200.

In the present disclosure, the shooting range may refer to the geographic range shot by the photographing device 220 or the photographing device 230. The shooting range may be defined by a latitude, a longitude, and an altitude. The shooting range may be a range of three-dimensional spatial data defined by a latitude, a longitude, and an altitude. The shooting range may be specified according to the angle of view and shooting direction of the photographing device 220 or the photographing device 230, and the position where the UAV 100 is located. The shooting directions of the photographing device 220 and the photographing device 230 may be defined by the azimuth and depression angles faced by the fronts of the photographing device 220 and the photographing device 230 on which the photographing lenses are disposed. The shooting direction of the photographing device 220 may be a direction designated by the orientation of the nose of the UAV 100 and the attitude of the photographing device 220 with respect to the gimbal 200. The shooting direction of the photographing device 230 may be a direction designated by the orientation of the nose of the UAV 100 and the position where the photographing device 230 is disposed.

The UAV controller 110 controls the flight of the UAV 100 by controlling the rotor mechanism 210. That is, the UAV controller 110 controls the position including the latitude, longitude, and altitude of the UAV 100 by controlling the rotor mechanism 210. The UAV controller 110 can control the shooting range of the photographing device 220 and the photographing device 230 by controlling the flight of the UAV 100. The UAV controller 110 can control the angle of view of the photographing device 220 by controlling the zoom lens included in the photographing device 220. The UAV controller 110 can use the digital zoom function of the photographing device 220 to control the angle of view of the photographing device 220 through digital zoom.

When the photographing device 220 is fixed to the UAV 100 and the photographing device 220 is not moved, the UAV controller 110 can move the UAV 100 to a specific position on a specific date, so that the photographing device 220 can shoot a desired shooting range in a desired environment. In some embodiments, when the photographing device 220 does not have a zoom function and the angle of view of the photographing device 220 cannot be changed, the UAV controller 110 can move the UAV 100 to a specific position on a specific date, so that the photographing device 220 can shoot a desired shooting range in a desired environment.

The UAV controller 110 can set a flight mode of the UAV 100. The flight mode includes, for example, a normal flight mode, a low-speed flight mode, a temporary stop mode, and etc. The set flight mode information can be stored in the memory 160. The normal flight mode is a flight mode that allows flying without a speed limit. The low-speed flight mode is a flight mode that prohibits flying at speeds above a specified speed and allows flying with a speed limit. The temporary stop mode is a flight mode in which the UAV 100 is prohibited from moving and can hover.

The UAV controller 110 adds information related to the shot image to the shot image shot by the photographing device 220 as additional information (an example of metadata). The additional information may include various parameters. The various parameters may include parameters related to the flight of the UAV 100 at the time of shooting (flight parameters) and information related to shooting by the photographing device 220 at the time of shooting (shooting parameters). The flight parameters may include at least one of shooting position information, shooting path information, shooting time information, or other information. The shooting parameters may include at least one of shooting angle of view information, shooting direction information, shooting attitude information, shooting range information, or object distance information.

The shooting path information indicates a path (shooting path) for shooting a shot image. The shooting path information is information about a path that the UAV 100 flies during shooting, and may include a collection of shooting positions in which the shooting positions are continuously connected. The shooting position can be based on a position obtained by the GPS receiver 240. The shooting time information indicates a time at which the shot image was shot (shooting time). The shooting time information may be based on the time information of a timer referred to by the UAV controller 110.

The shooting angle of view information indicates the angle of view information of the photographing device 220 when the shot image was shot. The shooting direction information indicates the shooting direction of the photographing device 220 when the shot image was shot. The shooting attitude information indicates attitude information of the photographing device 220 when the shot image was shot. The shooting range information indicates the shooting range of the photographing device 220 when the shot image is shot. The object distance information indicates information about a distance from the photographing device 220 to the object. The object distance information may be based on the detection information measured by the ultrasonic sensor 280 or the laser measurement device 290.

The communication interface 150 communicates with the transmitter 50, the terminal 80, and the server 300. The communication interface 150 receives various commands and information to the UAV controller 110 from the remote transmitter 50. The communication interface 150 can send the shot images and additional information related to the shot images to the terminal 80.

The memory 160 stores a program needed by the UAV controller 110 for controlling the gimbal 200, the rotor mechanism 210, the photographing device 220, the photographing device 230, the GPS receiver 240, the inertial measurement unit 250, the magnetic compass 260, the barometric altimeter 270, the ultrasonic sensor 280, and the laser measurement device 290. The memory 160 may be a computer-readable recording medium, and may include at least one of flash memories such as a static random access memory (SRAM), a dynamic random access memory (DRAM), an erasable programmable read only memory (EPROM), an electrically erasable programmable read-only memory (EEPROM), or a USB memory. The memory 160 may be provided inside the UAV main body 102 and can be configured to be detachable from the UAV main body 102.

The gimbal 200 rotatably supports the photographing device 220 with at least one axis as a center. The gimbal 200 may rotatably support the photographing device 220 with the yaw axis, the pitch axis, and the roll axis as the center. The gimbal 200 can change the shooting direction of the photographing device 220 by rotating the photographing device 220 about at least one of the yaw axis, the pitch axis, or the roll axis.

The rotor mechanism 210 includes a plurality of rotors 211, a plurality of drive motors 212 that rotate the plurality of rotors 211, and a current sensor 213 that measures a current value (actual value) of a drive current for driving the drive motor 212. The drive current is supplied to the drive motor 212.

The photographing device 220 shoots an object in the desired shooting range and generates shot image data. The image data obtained by shooting by the photographing device 220 is stored in a memory of the photographing device 220 or the memory 160.

The photographing device 230 shoots the surroundings of the UAV 100 and generates shot image data. The image data of the photographing device 230 is stored in the memory 160.

The GPS receiver 240 receives a plurality of signals indicating the time transmitted from a plurality of navigation satellites (i.e., GPS satellites) and the position (coordinate) of each GPS satellite. The GPS receiver 240 calculates a position of the GPS receiver 240 (that is, the position of the UAV 100) based on the received plurality of signals. The GPS receiver 240 outputs the position information of the UAV 100 to the UAV controller 110. In addition, the UAV controller 110 may replace the GPS receiver 240 to calculate the position information of the GPS receiver 240. In this scenario, the UAV controller 110 is input with information indicating the time and the position of each GPS satellite included in the plurality of signals received by the GPS receiver 240.

The inertial measurement unit 250 detects the attitude of the UAV 100 and outputs the detection result to the UAV controller 110. The inertial measurement unit 250 detects accelerations in directions of three axes of front to back, left to right, and up to down of the UAV 100, and angular velocities in directions of three axes of the pitch axis, the roll axis, and the yaw axis as the attitude of the UAV 100.

The magnetic compass 260 detects the orientation of the nose of the UAV 100 and outputs a detection result to the UAV controller 110.

The barometric altimeter 270 detects a flying altitude of the UAV 100 and outputs a detection result to the UAV controller 110.

The ultrasonic sensor 280 emits ultrasonic waves, detects ultrasonic waves reflected by the ground and objects, and outputs a detection result to the UAV controller 110. The detection result may indicate a distance from the UAV 100 to the ground, that is, the altitude. The detection result may indicate a distance from the UAV 100 to the object.

The laser measurement device 290 irradiates laser light on the object, receives reflected light reflected by the object, and measures a distance between the UAV 100 and the object through the reflected light. A time-of-flight method may be used as an example of a distance measurement method according to laser.

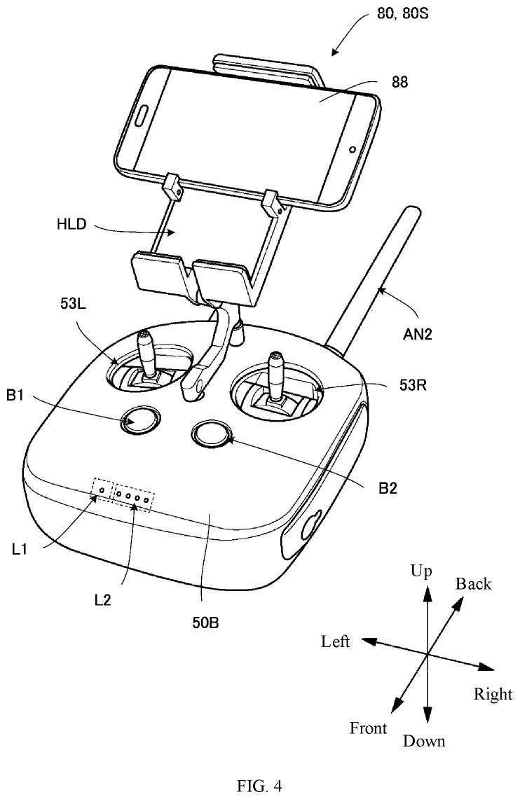

FIG. 4 is a perspective view of the terminal 80 provided with the transmitter 50 according to an embodiment. As an example of the terminal 80, a smart phone 80S is shown in FIG. 4. The directions of up, down, front, back, left, and right with respect to the transmitter 50 respectively follow the directions of the arrows shown in FIG. 4. The transmitter 50 is used in a state where a person who uses the transmitter 50 (hereinafter referred to as an “operator”) holds it with both hands, for example.

The transmitter 50 includes a casing 50B, which, for example, is made of a resin material and has a substantially cuboid (in other words, substantially box-shaped) shape having a substantially square bottom surface and a height shorter than one side of the bottom surface. A left joystick 53L and a right joystick 53R are provided at an approximate center of a casing surface of the transmitter 50.

The left joystick 53L and the right joystick 53R are respectively used for remote control (such as a forward and backward movement, a left and right movement, a up and down movement, an orientation change of the UAV 100) by the operator for operating the movement of the UAV 100. In FIG. 4, the left joystick 53L and the right joystick 53R represent the positions of an initial state where no external force is applied by the hands of the operator. The left joystick 53L and the right joystick 53R automatically return to a predetermined position (for example, the initial position shown in FIG. 4) after the external force applied by the operator is released.

A power button B1 of the transmitter 50 is disposed at a near front side (in other words, the operator's side) of the left joystick 53L. When the operator presses the power button B1 once, a remaining capacity of a battery (not shown) built in the transmitter 50 is displayed at a remaining battery level indicator L2. When the operator presses the power button B1 again, the power of the transmitter 50 is turned on, and power can be supplied to various parts of the transmitter 50.

A return-to-home (RTH) button B2 is disposed at a near front side (in other words, the operator's side) of the right joystick 53R. When the operator presses the RTH button B2, the transmitter 50 transmits a signal for automatically returning to a predetermined position to the UAV 100. Thus, the transmitter 50 can automatically return the UAV 100 to a predetermined position (for example, a take-off position stored in the UAV 100). For example, during an outdoor shooting using the UAV 100, when the operator loses sight of the body of the UAV 100, or is not able to operate due to radio interference or unexpected failure, the RTH button B2 can be used.

A remote status indicator L1 and a remaining battery level indicator L2 are disposed at a near front side (in other words, the operator's side) of the power button B1 and the RTH button B2. The remote status indicator L1 may include a light emission diode (LED) light, and display a wireless connection status between the transmitter 50 and the UAV 100. The remaining battery level indicator L2 may include LED lights, and display the remaining level of the capacity of the battery (not shown) built in the transmitter 50.

Behind the left joystick 53L and right joystick 53R, two antennas AN1 and AN2 are protruding from a rear side of the casing 50B of the transmitter 50. The antennas AN1 and AN2 transmit a signal generated by a transmitter controller 61 (that is, the signal used to control the movement of the UAV 100) to the UAV 100 according to the operator's operation of the left joystick 53L and the right joystick 53R. This signal is one of the operation input signals input by the transmitter 50. The antennas AN1 and AN2 can cover a transmission and reception range of 2 km. In addition, when images shot by the photographing device 220 of the UAV 100 that is wirelessly connected to the transmitter 50, or various data obtained by the UAV 100 are transmitted from the UAV 100, the antennas AN1 and AN2 can receive these images or various data.

In the example shown in FIG. 4, the transmitter 50 does not include a display. In some other embodiments, the transmitter 50 may include a display.

The terminal 80 can be mounted at a holder HLD. The holder HLD may be attached and mounted at the transmitter 50. Therefore, the terminal 80 is mounted at the transmitter 50 through the holder HLD. The terminal 80 and the transmitter 50 may be connected via a cable (such as a USB cable). In some other embodiments, the terminal 80 may not be mounted at the transmitter 50, and the terminal 80 and the transmitter 50 may be independently disposed.

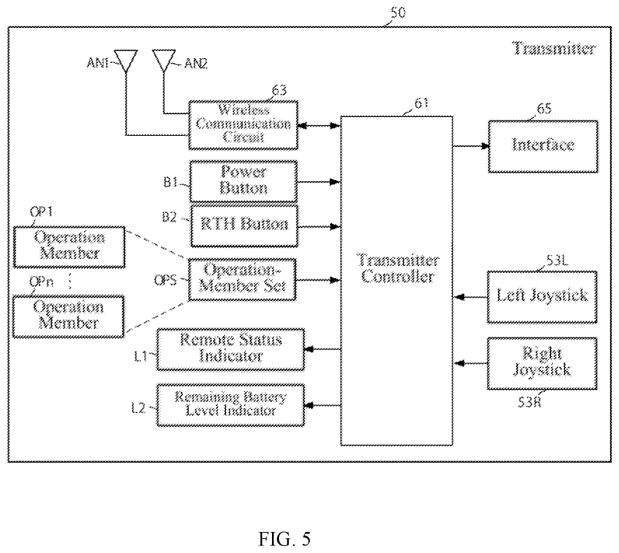

FIG. 5 is a block diagram showing a hardware configuration of the transmitter 50 according to an embodiment. The transmitter 50 includes the left joystick 53L, the right joystick 53R, the transmitter controller 61, a wireless communication circuit 63, an interface 65, the power button B1, the RTH button B2, an operation-member set OPS, the remote status indicator L1, the remaining battery level indicator L2, and a display DP. The transmitter 50 is an example of an operation device that instructs the control of the UAV 100.

The left joystick 53L can be used for the operation of remotely controlling the movement of the UAV 100 with an operator's left hand. The right joystick 53R can be used for the operation of remotely controlling the movement of the UAV 100 with an operator's right hand. The movement of the UAV 100 may be one or any combination of a movement in a forward direction, a movement in a backward direction, a movement in a left direction, a movement in a right direction, a movement in an upward direction, a movement in a downward direction, a movement of the UAV 100 rotating to the left, or a movement of the UAV 100 rotating to the right.

Once the power button B1 is pressed once, a signal indicating that it is pressed once is input to the transmitter controller 61. Based on the signal, the transmitter controller 61 displays the remaining capacity of the battery (not shown in the figure) built in the transmitter 50 on the remaining battery level indicator L2. Therefore, the operator can easily confirm the remaining capacity of the battery built in the transmitter 50. In addition, when the power button B1 is pressed twice, a signal indicating that it is pressed twice is input to the transmitter controller 61. Based on this signal, the transmitter controller 61 instructs the battery (not shown in the figure) built in the transmitter 50 to supply power to each unit of the transmitter 50. As a result, the operator turns on the power of the transmitter 50, and can easily start the use of the transmitter 50.

When the RTH button B2 is pressed, a signal indicating that it is pressed is input to the transmitter controller 61. Based on the signal, the transmitter controller 61 generates a signal for automatically returning the UAV 100 to a predetermined position (for example, a take-off position of the UAV 100), and transmits it to the UAV via the wireless communication circuit 63 and the antennas AN1 and AN2. As a result, the operator can automatically restore (return) the UAV 100 to a predetermined position through a simple operation of the transmitter 50.

The operation-member set OPS includes a plurality of operation members OP (for example, an operation member OP1, . . . , an operation member OPn) (n is an integer greater than or equal to 2). The operation-member set OPS can include operation members (for example, various operation members for assisting the remote control of the UAV 100 using the transmitter 50) other than the left joystick 53L, the right joystick 53R, the power button B1, and the RTH button B2 shown in FIG. 3. The various operation members mentioned here may correspond to buttons for instructing a shooting of still images using the photographing device 220 of the UAV 100, buttons for instructing a start and end of recording of dynamic images using the photographing device 220 of the UAV 100, dials to adjust an inclination of the gimbal 200 (referring to FIG. 2) of the UAV 100, buttons to switch a flight mode of the UAV 100, or dials to set up the photographing device 220 of the UAV 100.

Since the remote status indicator L1 and the remaining battery level indicator L2 have been described with reference to FIG. 4, the description is omitted here.

The transmitter controller 61 includes a processor (for example, a CPU, MPU, or DSP). The transmitter controller 61 performs signal processing for overall control of the operations of various units of the transmitter 50, processing of data input/output with other units, data arithmetic processing, and data storage processing. The transmitter controller 61 is an example of a processing circuit.

The transmitter controller 61 can obtain the shot image data taken by the photographing device 220 of the UAV 100 through the wireless communication circuit 63 and store it in a memory (not shown in the figure), and output to the terminal 80 through the interface 65. In other words, the transmitter controller 61 can cause the terminal 80 to display the data of the shot image shot by the photographing device 220 of the UAV 100. Therefore, the shot image shot by the photographing device 220 of the UAV 100 can be displayed on the terminal 80.

The transmitter controller 61 can generate an instruction signal for controlling the flight of the UAV 100 designated by an operator's operation of the left joystick 53L and the right joystick 53R. The transmitter controller 61 can remotely control the UAV 100 by sending the instruction signal to the UAV 100 through the wireless communication circuit 63 and the antennas AN1 and AN2. Thereby, the transmitter 50 can remotely control the movement of the UAV 100.

The wireless communication circuit 63 is connected to the two antennas AN1 and AN2. The wireless communication circuit 63 uses two antennas AN1 and AN2 to transmit and receive information and data to and from the UAV 100 using a predetermined wireless communication mean (for example, a wireless LAN).

The interface 65 performs input and output of information and data between the transmitter 50 and the terminal 80. The interface 65 may be a USB port (not shown in the figure) provided at the transmitter 50. The interface 65 may be an interface other than the USB port.

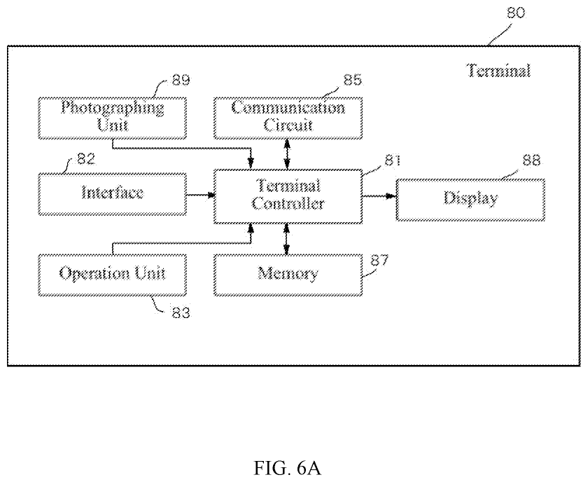

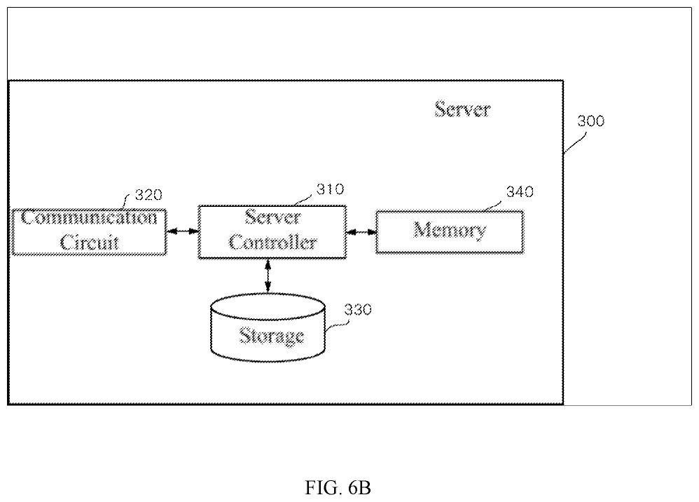

FIG. 6A is a block diagram showing a hardware configuration of the terminal 80 according to an embodiment.

The terminal 80 may include a terminal controller 81, an interface 82, an operation unit 83, a communication circuit 85, a memory 87, a display 88, and a photographing unit 89. The display 88 is an example of a prompt device.

The terminal controller 81 can include a processor, such as a CPU, an MPU, or a DSP. The terminal controller 81 performs signal processing for overall control of the operation of each unit of the terminal 80, processing of data input/output with other units, data arithmetic processing, and data storage processing. The terminal controller 81 is an example of a processing circuit.

The terminal controller 81 can obtain data and information from the UAV 100 via the communication circuit 85. For example, the terminal controller 81 may obtain a shot image from the UAV 100 and its additional information via the communication circuit 85. The terminal controller 81 can obtain data and information from the transmitter 50 through the interface 82. The terminal controller 81 can obtain data and information input through the operation unit 83. The terminal controller 81 can obtain data and information stored in the memory 87. The terminal controller 81 can send data and information to the display 88, and display information on the display 88 based on the data and information.

The terminal controller 81 may directly obtain position information of the UAV 100 from the UAV 100 via the communication circuit 85, or obtain position information of the UAV 100 as shooting position information included in the additional information. The terminal controller 81 may sequentially obtain the position information of the UAV 100, and calculate the information of a moving speed and a moving direction of the UAV 100 based on the position information. Information of the position, speed, and moving direction of the UAV 100 may be included in the additional information and notified to the server 300, or the like.

The terminal controller 81 may execute an application program for instructing the control of the UAV 100. The terminal controller 81 can generate various data used in the application program.

The terminal controller 81 can obtain a shot image from the UAV 100. The terminal controller 81 can cause the display 88 to display the shot image from the UAV 100.

The terminal controller 81 can obtain an image (user image) of the peripheral part of user's eyes shot by the photographing unit 89. The user image may be an image shot when the user observes the display 88 on which the shot image from the UAV 100 is displayed. The terminal controller 81 detects the eyes (for example, pupils) of the user by performing image recognition (for example, segmentation processing, object recognition processing) on the shot image.

The terminal controller 81 can detect a point of interest that the user who operates the terminal 80 pays attention to in the shot image displayed on the display 88. In this scenario, the terminal controller 81 can use sight line detection technology to obtain a position (sight line detection position) on the image that the user looks at, that is, the coordinates of the point of interest, on the display 88 where the shot image is displayed. That is, the terminal controller 81 can recognize which position of the shot image displayed on the display 88 is observed by the user's eyes.

The terminal controller 81 can obtain the shooting range information included in the additional information related to the shot image from the UAV 100. That is, the terminal controller 81 can specify a geographic shooting range as a range on the map based on the shooting range information from the UAV 100. The terminal controller 81 can detect a position of the shot image displayed on the display 88 corresponding to the coordinates of the point of interest, and detect a position in the geographic shooting range indicated by the range of the shot image corresponding to the point of interest. As a result, a specified position included in the geographic shooting range can be detected as the point of interest.

The terminal controller 81 can communicate with an external map server having a map database via the communication circuit 85, and can detect objects existing on the map at a geographically designated location corresponding to the point of interest. As a result, the specified objects included in the geographic shooting range can be detected as the point of interest. In addition, the memory 87 may have a map database that the map server has.

The terminal controller 81 can recognize various objects in the shot image by performing image recognition (for example, segmentation processing, object recognition processing) on the shot image from the UAV 100. In this scenario, for example, even when the information in the map database is relatively old, it is possible to recognize the object reflected in the shot image at the time of shooting.

The information of the point of interest may be location information (latitude and longitude, or latitude, or longitude and altitude), or information about an object identified by a unique name such as ◯ ◯ tower. In addition, the information of the object may include information and location information of the object in addition to the unique name such as ◯ ◯ tower. In addition, the mean of detecting the point of interest is an example, and the point of interest may also be detected by other means.

The interface 82 performs input/output of information and data between the transmitter 50 and the terminal 80. The interface 82 may be a USB port (not shown in the figure) provided at the terminal 80. The interface 82 may be an interface other than the USB port.

The operation unit 83 receives data and information input by the operator of the terminal 80. The operation unit 83 may include buttons, keys, a touch screen, a microphone, or the like. In some embodiments, the operation unit 83 and the display 88 include a touch screen. In this scenario, the operation unit 83 can accept touch operations, click operations, drag operations, or the like.

The communication circuit 85 communicates with the UAV 100 through various wireless communication means. The wireless communication method may include a communication through wireless LAN, a Bluetooth®, a short-range wireless communication, or a public wireless network. Further, the communication circuit 85 may perform a wired communication.

The memory 87 may include a program that defines operations of the terminal 80, a ROM that stores data of predetermined values, and a RAM that temporarily stores various information and data used when the terminal controller 81 performs processing. The memory 87 may include memory other than ROM and RAM. The memory 87 may be provided inside the terminal 80. The memory 87 may be configured to be detachable from the terminal 80. Programs can include application programs.

The display 88 can include a liquid crystal display (LCD), and displays various information and data output from the terminal controller 81. The display 88 can display the data of the shot image shot by the photographing device 220 of UAV 100.

The photographing unit 89 includes an image sensor and shoots an image. The photographing unit 89 may be provided at the front side including the display 88. The photographing unit 89 may take an image (user image) with an object including the periphery of the user's eyes viewing the image displayed by the display 88 as a subject. The photographing unit 89 can output the user image to the terminal controller 81. The photographing unit 89 may also shoot images other than the user image.

FIG. 6B is a block diagram showing a hardware configuration of the server 300. The server 300 is an example of an information processing device. The server 300 includes a server controller 310, a communication circuit 320, a memory 340, and a storage 330.

The server controller 310 may include a processor, such as a CPU, an MPU, or a DSP. The server controller 310 performs signal processing for overall control of the operations of each unit of the server 300, processing of data input/output with other units, data arithmetic processing, and data storage processing.

The server controller 310 can obtain data and information from the UAV 100 via the communication circuit 320. The server controller 310 can obtain data and information from the terminal 80 via the communication circuit 320. The server controller 310 can execute an application program for instructing the control of the UAV 100. The server controller 310 can generate various data used in the application program.

The server controller 310 performs processing related to instructions for prompting information for avoiding a collision of the UAV 100. The server controller 310 prompts information based on the user's point of interest in the image shot by the UAV 100.

The server controller 310 may directly obtain position information of the UAV 100 from the UAV 100 via the communication circuit 320, or obtain position information of the UAV 100 from each terminal 80 as shooting position information included in the additional information. The server controller 310 may sequentially obtain the position information of the UAV 100 and calculate the information of a moving speed and a moving direction of the UAV 100 based on the position information. The server controller 310 may obtain information of the position, speed, and moving direction of the UAV 100 included in the additional information from each terminal 80 via the communication circuit 320.

The memory 340 may include a program that controls operations of the server 300, a ROM that stores data of predetermined values, and a RAM that temporarily stores various information and data used when the server controller 310 performs processing. The memory 340 may include memory other than ROM and RAM. The memory 340 may be provided inside the server 300. The memory 340 can be configured to be detachable from the server 300. Programs can include application programs.

The communication circuit 320 can communicate with other devices (for example, the transmitter 50, the terminal 80, and the UAV 100) by wire or wireless. The storage 330 may be a large-capacity recording medium capable of storing shot images, map information, or the like.

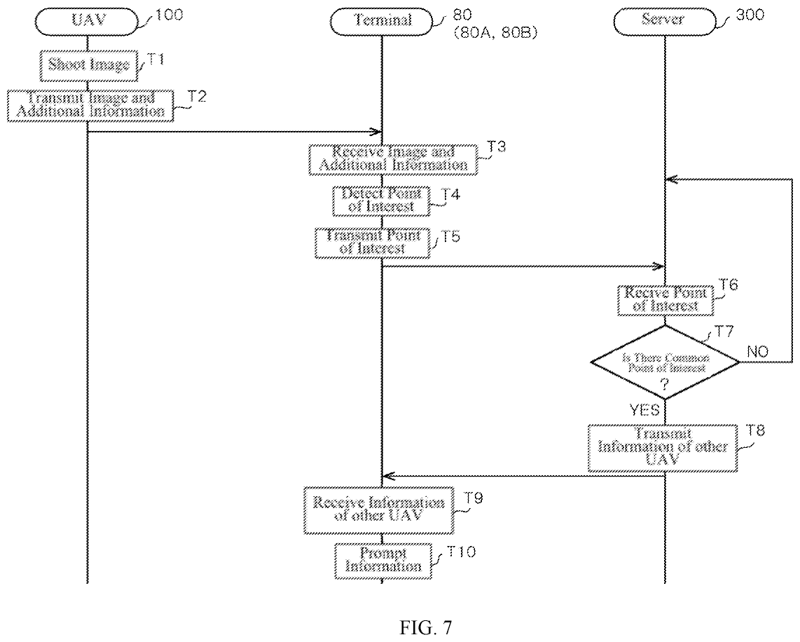

FIG. 7 is a sequence diagram showing an instruction process for prompting information performed by the server 300 according to a first operation example. In some embodiments, it is assumed that the transmitter 50 and the terminal 80 are used to cause the UAV 100 to perform an FPV flight. During the FPV flight, the operators of the transmitter 50 and the terminal 80 do not need to look at the UAV 100. For example, the operators can operate the UAV 100 while observing the shot image by the UAV 100 displayed on the display 88 of the terminal 80.

In some embodiments, a plurality of users operate a transmitter 50 and a terminal 80 that instruct a control of a flight of a UAV 100A. For example, a user Ua (user U1) operates the transmitter 50 and the terminal 80 that instruct the control of the flight of the UAV 100A. A user Ub (user U2) operates a transmitter 50 and a terminal 80 that instruct a control of a flight of another UAV 100B.

In addition, various parts of the transmitter 50, the terminal 80, and the UAV 100 operated by user A are marked with “A” at the end of the symbol (for example, a terminal 80A, a display 88A, a UAV 100A). Various parts of the transmitter 50 and the terminal 80 operated by user B are marked with “B” at the end of the symbol (for example, a terminal 80B, a display 88B, and a UAV 100B). In addition, there may be multiple UAVs 100B, terminals 80B, and users Ub.

As shown in FIG. 7, at T1, during the flight, the photographing device 220 of the UAV 100 (for example, the UAV 100A) repeatedly shoots images. The UAV controller 110 may store the shot images taken by the photographing device 220 in the memory 160, and also store additional information related to the shot image in the memory 160. At T2, the UAV controller 110 transmits the shot image and its additional information stored in the memory 160 to the terminal 80 via the communication interface 150.

At T3, the terminal controller 81 of the terminal 80 (for example, the terminal 80A) receives the shot image and the additional information transmitted from the UAV 100A via the communication circuit 85. The terminal controller 81 causes the display 88 to display the shot image. At T4, the terminal controller 81 detects a point of interest that the user operating the terminal 80 pays attention to in the shot image displayed on the display 88.

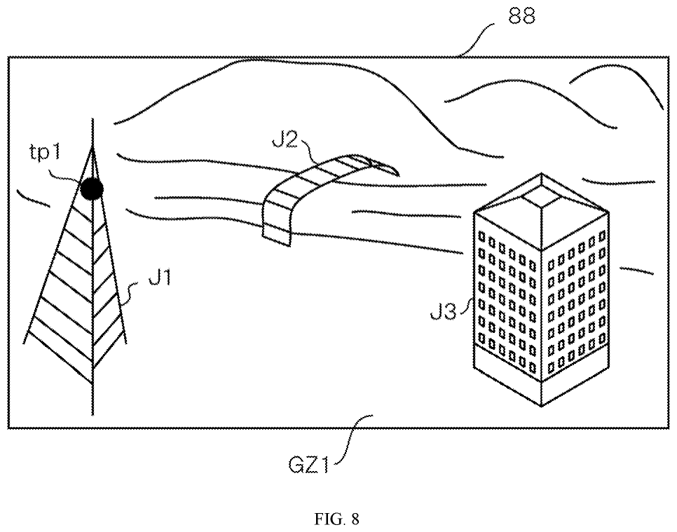

FIG. 8 is a diagram showing a detection of the point of interest according to an embodiment. In some embodiments, the shot image GZ1 shot by the photographing device 220 is displayed on the display 88. The terminal controller 81 determines that a tower J1 is the position of the user's sight line using sight line detection technology on the shot image GZ1 displayed on the display 88 and detects the point of interest tp1.

Referring again to FIG. 7, at T5, the terminal controller 81 transmits the information of the point of interest to the server 300 via the communication circuit 85. In addition, the terminal controller 81 may also transmit at least a part of the additional information obtained by the terminal 80 from the UAV 100 in addition to the information of the point of interest via the communication circuit 85.

At T6, the server controller 310 of the server 300 receives information (for example, information of the point of interest) transmitted from the terminal 80 via the communication circuit 320 and stores it in the storage 330. In addition to the UAV 100A, the server 300 also receives information (for example, information of the point of interest) from other UAV 100B, and stores it in the storage 330.

At T7, the server controller 310 determines whether there exists information of multiple points of interest that have same (common) position information and objects among the information of one or more points of interest stored in the storage 330. The points of interest in common, that is, the points of interest that have common position information and objects, is also referred to as common points of interest.

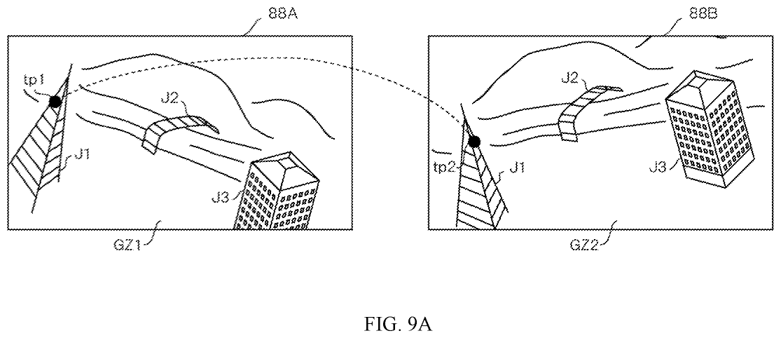

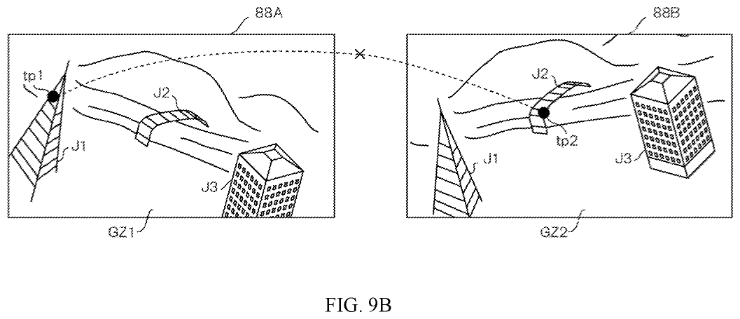

FIG. 9A is a diagram showing shot images GZ1 and GZ2 displayed on respective displays 88 when the points of interest of two users (operators) are common points of interest. The two users can be users U1 and U2.

The shot images GZ1 and GZ2 are images with different shooting directions taken by the photographing devices 220 of the UAV 100A and UAV 100B, and each include the tower J1, a bridge J2, and a building J3. In FIG. 9A, the points of interest tp1 and tp2 are the tower J1, which are common, and therefore are common points of interest.

FIG. 9B is a diagram showing shot images GZ1 and GZ2 respectively displayed on the displays 88A and 88B of respective terminals when the points of interest of two users are not common points of interest. In FIG. 9B, the point of interest tp1 with respect to the shot image GZ1 is the tower J1. On the other hand, the point of interest tp2 with respect to the shot image GZ2 is the bridge. Therefore, the points of interest tp1 and tp2 are not common points of interest.

In addition, when the information of the point of interest is not information about objects such as towers but geographic position information, in some embodiments, when a distance between two points of interest is less than a threshold, the points of interest can also be determined as common points of interest.

When there is no information of a plurality of common points of interest, that is, when there is no common point of interest, the server controller 310 returns to the previous process T6 in FIG. 7.

In some embodiments, when there is information of a plurality of common points of interest as determined at process T7, the server controller 310 transmits information of other UAV 100B different from the UAV 100A, for which the terminal 80A instructs flight control, to the terminal 80A that has transmitted the information about the common points of interest via the communication circuit 320 at process T8. Similarly, at T8, the server controller 310 transmits the information of the UAV 100A different from the UAV 100B, for which the terminal 80B instructs flight control, to the terminal 80B that has transmitted the information about the common points of interest via the communication circuit 320.

The information of the other UAV 100B may include information indicating the presence of the other UAV 100B, position information of the other UAV 100B, or information of a moving direction of the other UAV 100B. Similarly, the information of the UAV 100A may include information indicating the presence of the UAV 100A, position information of the UAV 100A, or information of a moving direction of the UAV 100A.

At T9, the terminal controller 81 of the terminal 80A receives the information of the other UAV 100B via the communication circuit 85. Similarly, the terminal controller 81 of the other terminal 80B receives the information of the UAV 100A. At T10, the terminal controller 81 of the terminal 80A causes the display 88 to display a superimposed image on the shot image GZ1 displayed on the display 88 based on the received information of the UAV 100B. Displaying the superimposed image is an example of prompting information, such as prompting information of the other UAV 100B to the terminal 80A.

As the superimposed image, an arrow-like mark mk1 may be superimposed and displayed on the shot image GZ1. In addition, the terminal controller 81 of the terminal 80A may display information of other UAV 100B in addition to displaying the mark mk1 that is a superimposed image on the shot image GZ1 displayed on the display 88. For example, the terminal controller 81 may also display the presence or absence of other UAV, the position, speed, and moving direction of the other UAV.

Although the information of the other UAV 100B is displayed in this embodiment, the information of the other UAV 100B may be presented by a method other than being displayed. For example, the terminal 80 may include a loudspeaker to output sound information of the other UAV 100B. For example, the terminal 80 may also include a vibrator to indicate information of the UAV 100B through vibration.

According to the process shown in FIG. 7, the server 300 obtains information of the points of interest from each terminal 80 and determines whether there is a common point of interest among the obtained multiple points of interest. The point of interest is the position and object that the user pays attention to, and hence the possibility of the UAV 100 flying toward the point of interest is high. Therefore, when the point of interest is a common point of interest, as the geographic position corresponding to the point of interest is approached, the possibility of the UAVs 100 colliding with each other becomes higher. Even in such a scenario, the user of each terminal 80 can prompt information related to other UAV 100 operated by other users to the own aircraft that is confirming during FPV flight. Therefore, the user of each terminal 80 can recognize that other users also pay attention to the same point of interest, and can operate the UAV 100 with improved safety.

In some embodiments, between the processes T6 and T7, the server controller 310 may also determine whether the UAVs 100A and 100B that have received the points of interest are moving. In this scenario, the server controller 310 may obtain the information of the point of interest via the communication circuit 320, and further sequentially obtain the position information of the UAVs 100A and 100B. The position information may be included in the additional information of the shot image as the shooting position information, which is sequentially obtained from the terminals 80A and 80B via the communication circuit 320, or may be directly obtained from the UAVs 100A and 100B sequentially. Further, the server controller 310 may instruct to prompt based on the information of the common point of interest when at least one of the UAV 100A or 100B is moving, or may not instruct to prompt based on the information of the common point of interest when neither of the UAVs 100A and 100B is moving.

In other words, when the UAVs 100A and 100B are moving and pay attention to a common position and object, the possibility of collision becomes high, and therefore, the server 300 can instruct to prompt information. When both the UAVs 100A and 100B are not moving, and even if they pay attention to a common position and object, the possibility of the UAVs 100A and 100B colliding is low, therefore, the server 300 does not need to instruct to prompt information.

In this way, the server controller 310 can determine whether the UAV 100A is moving. When the UAV 100A is moving, the server controller 310 may cause the terminal 80A to display information related to the UAV 100B.

When the UAV 100A is moving, the possibility of collision with another UAV 100B becomes high. Even in this scenario, the server 300 can notify the information of the other UAV 100B as warning information, and a collision of the UAV 100A with the UAV 100B can be prevented.

In some embodiments, the server controller 310 of the server 300 may calculate a distance r1 between the UAV 100A and the UAV 100B based on the obtained position information of the UAV 100A and the UAV 100B. When the distance r1 is less than or equal to a threshold value, the server controller 310 may cause the terminal 80A to display information related to the UAV 100B, such as a mark indicating the presence of the UAV 100B. The threshold here may be the same as a threshold Dist1 used in another example described later.

As a result, even when a plurality of UAVs 100 are flying close to each other, and the possibility of the plurality of UAV 100 colliding becomes high, the user U1 who instructs the control of the flight of the UAV 100A is able to learn the presence of other UAV 100B. Therefore, the server 300 can suppress the occurrence of a collision between the UAV 100A and the UAV 100B.

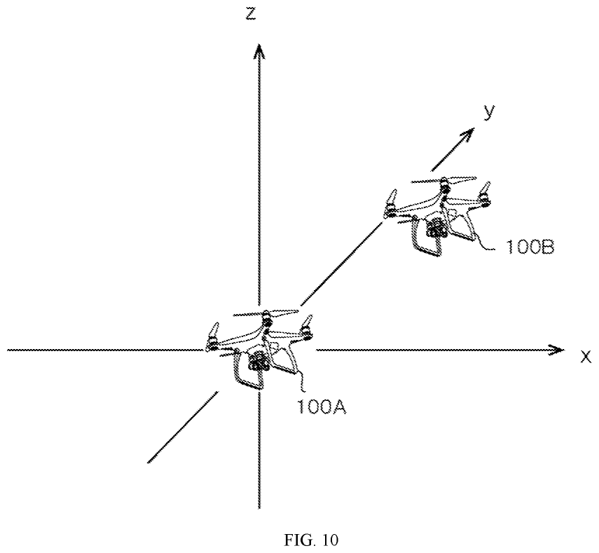

FIG. 10 is a diagram showing a positional relationship between two UAVs 100A and 100B. A three-dimensional coordinate system is set with the UAV 100A as an origin point. As shown in FIG. 10, the UAV 100B is located at a positive x direction, a positive y direction, and a positive z direction (i.e., a position above the UAV 100A).

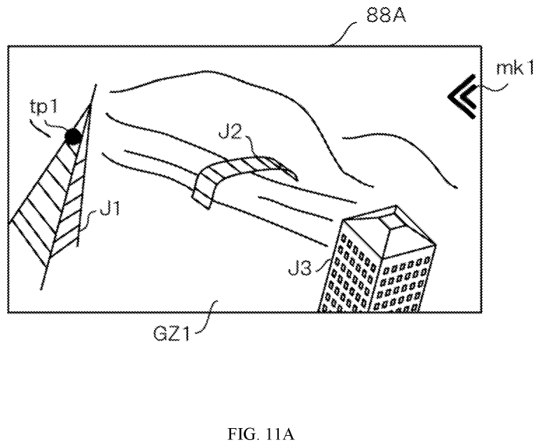

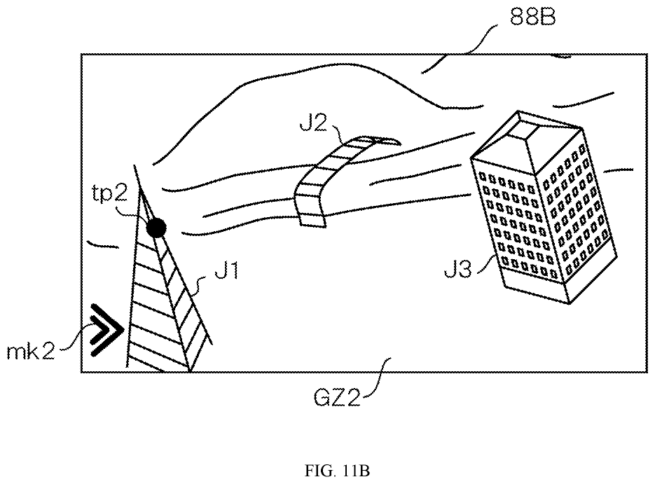

FIG. 11A is a diagram showing a shot image GZ1 shot by the UAV 100A and displayed on the display 88A of the terminal 80A. In FIG. 11A, it is assumed that the positional relationship between the UAV 100A and the UAV 100B is the positional relationship shown in FIG. 10.

The terminal controller 81A of the terminal 80A receives an instruction to display information from the server 300 (referring to T8 in FIG. 7), and displays various information via the display 88A. As shown in FIG. 11A, at the upper right side of the display 88A, a mark mk1 similar to an arrow from right to left is displayed superimposed on the shot image GZ1. The mark mk1 indicates that the other UAV 100B is flying in the upper right direction as shown in FIG. 10, which is a blind zone on the display 88A. Therefore, if the shooting direction of the UAV 100A is shifted to the direction indicated by the mark mk1, the other UAV 100B will appear in the shot image GZ1.

In this scenario, the server controller 310 of the server 300 can obtain the position information of the UAV 100A via the communication circuit 320. The server controller 310 can obtain the position information of the UAV 100B via the communication circuit 320. The position information may be included in the additional information of the shot image as the shooting position information, which is sequentially obtained from the terminals 80A and 80B via the communication circuit 320, or may be directly obtained from the UAVs 100A and 100B sequentially. The server controller 310 may determine a position where the mark mk1 is displayed in consideration of the positional relationship between the UAVs 100A and 100B based on the position information of the UAVs 100A and 100B. The server controller 310 may instruct the terminal 80A via the communication circuit 320 to display information related to the UAV 100B (for example, information indicating the presence of the UAV 100B) including information of the position where the mark mk1 is displayed.

In some embodiments, the mark mk1 may also indicate a moving direction of the UAV 100B. That is, it may indicate that the UAV 100B is flying from right to left in the geographic range and orientation corresponding to the shot image displayed on the display 88A. In some embodiments, it is also possible to display information related to the UAV 100B such as a position and speed of the UAV 100B with information other than the mark mk1.

FIG. 11B is a diagram showing a shot image GZ2 shot by the UAV 100B and displayed on the display 88B of the other terminal 80B. In FIG. 11B, it is assumed that the positional relationship between the UAVs 100A and 100B is the positional relationship shown in FIG. 10.

At the lower left side of the display 88B, a mark mk2 similar to an arrow from left to right is displayed superimposed on the shot image GZ2. The mark mk2 indicates that the other UAV 100A is flying in the lower left direction as shown in FIG. 10, which is a blind zone on the display 88B. Therefore, if the shooting direction of the UAV 100B is shifted to the direction indicated by the mark mk2, the other UAV 100A will appear in the shot image GZ2.

In this scenario, the server controller 310 of the server 300 can obtain the position information of the UAV 100A via the communication circuit 320. The server controller 310 can obtain the position information of the UAV 100B via the communication circuit 320. The position information may be included in the additional information of the shot image as the shooting position information, which is sequentially obtained from the terminals 80A and 80B via the communication circuit 320, or may be directly obtained from the UAVs 100A and 100B sequentially. The server controller 310 may determine a position where the mark mk2 is displayed in consideration of the positional relationship between the UAVs 100A and 100B based on the position information of the UAVs 100A and 100B. The server controller 310 may instruct the terminal 80B via the communication circuit 320 to display information related to the UAV 100A (for example, information indicating the presence of the UAV 100A) including information of the position where the mark mk2 is displayed.

In some embodiments, the mark mk2 may also indicate a moving direction of the UAV 100A. That is, it may indicate that the UAV 100A is flying from left to right in the geographic range and orientation corresponding to the shot image displayed on the display 88B. In some embodiments, it is also possible to display information related to the UAV 100A such as a position and speed of the UAV 100A with information other than the mark mk2.

In this way, the server controller 310 of the server 300 can obtain the position information of the UAV 100A and the UAV 100B. The server controller 310 may instruct the display 88A to display information indicating the presence of the UAV 100B at a position according to the position of the UAV 100B relative to the UAV 100A.

As a result, the terminal 80A receives an instruction from the server 300, and can display the mark mk2 indicating the presence of the UAV 100B at a position (also referred to as a “prompt position”) based on the position of the UAV 100B relative to the UAV 100A, for example, at the upper right side of the screen of the display 88. The user U1 operating the terminal 80A easily and intuitively gets the position of the UAV 100B. Therefore, the user U1 can more easily operate the terminal 80A in consideration of the position of the UAV 100B. Therefore, server 300 can prevent the UAV 100A from colliding with the UAV 100B.

In some embodiments, in a scenario where the UAV 100A and the other UAV 100B corresponding to users paying attention to a common point of interest exist, even if the UAV 100B is not displayed in the shot image displayed at the display 88A of the terminal 80A, a mark mk1 indicating the UAV 100B is displayed.

In some embodiments, the server controller 310 obtains a point of interest tp1, which is a point that the user U1 operating the terminal 80A that instructs the control of the flight of the UAV 100A pays attention to at the shot image GZ1 shot by the UAV 100A and displayed at the terminal 80A. The server controller 310 obtains a point of interest tp2, which is a point that the user U2 operating the terminal 80B that instructs the control of the flight of the UAV 100B pays attention to at the shot image GZ2 shot by the UAV 100B and displayed at the terminal 80B. The server controller 310 determines whether the point of interest tp1 and the point of interest tp2 are a common point of interest representing the same point of interest. When these are the common point of interest, the server controller 310 causes the terminal 80A to display a mark mk1 indicating the presence and approach of the UAV 100B.

The server controller 310 is an example of a processing circuit. The UAV 100A is an example of a first flight body. The terminal 80A is an example of a first terminal. The shot image GZ1 is an example of a first image. The point of interest tp1 is an example of a first point of interest. The UAV 100B is an example of a second flight body. The terminal 80B is an example of a second terminal. The shot image GZ2 is an example of a second image. The point of interest tp2 is an example of a second point of interest.

Therefore, the user U1 can obtain the information regarding the UAV 100B existing around the UAV 100A. Therefore, when the UAV 100A is performing an FPV flight, it is difficult to confirm the surrounding conditions of the UAV 100A, and even if the destination is same as the destinations of the multiple UAV 100 corresponding to the common point of interest, the user U1 can operate the terminal 80A in consideration of the information related to the UAV 100B. Therefore, server 300 can prevent the UAV 100A from colliding with the UAV 100B.

In some embodiments, a marker indicating a presence of another UAV with a common point of interest is superimposed on a shot image and displayed on a display of a terminal. In some other embodiments, when the common point of interest is the same and a distance from other UAV is less than a threshold, recommended information is shown in the terminal that instructs the flight control of the UAV.

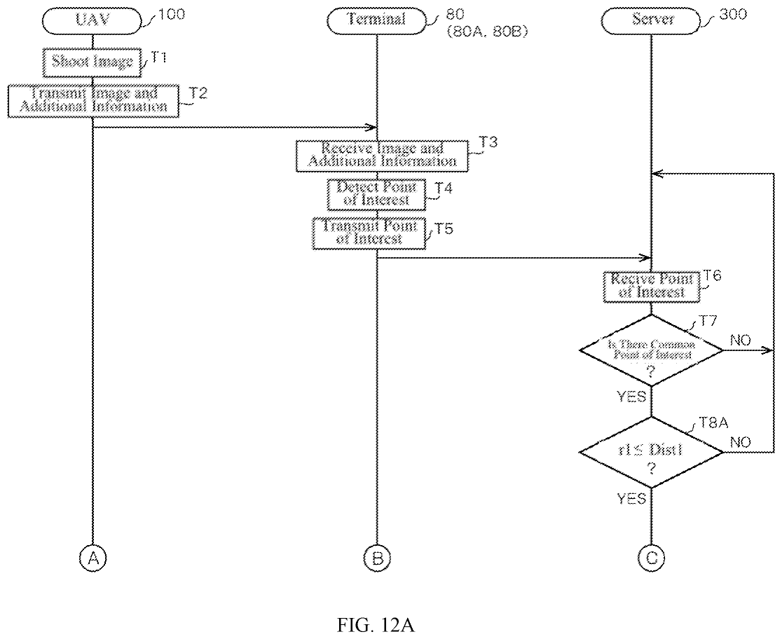

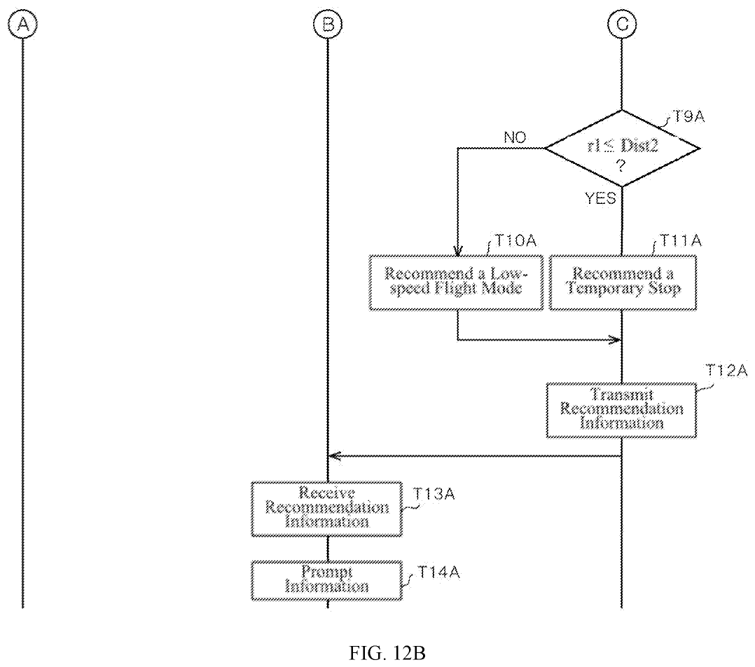

FIGS. 12A and 12B are sequence diagrams showing an instruction process for prompting information from a viewpoint of the UAV performed by the server 300 according to an embodiment. For the same processes as shown in FIG. 7, by using the same symbols, the description thereof is omitted or simplified.

First, the flight system 10 executes processes T1 to T6.

When there are a plurality of UAVs 100 having a same common point of interest at process T7, the server controller 310 of the server 300 determines whether a distance r1 from the UAV 100A to another UAV 100B is less than or equal to a threshold value Dist1 at process T8A.

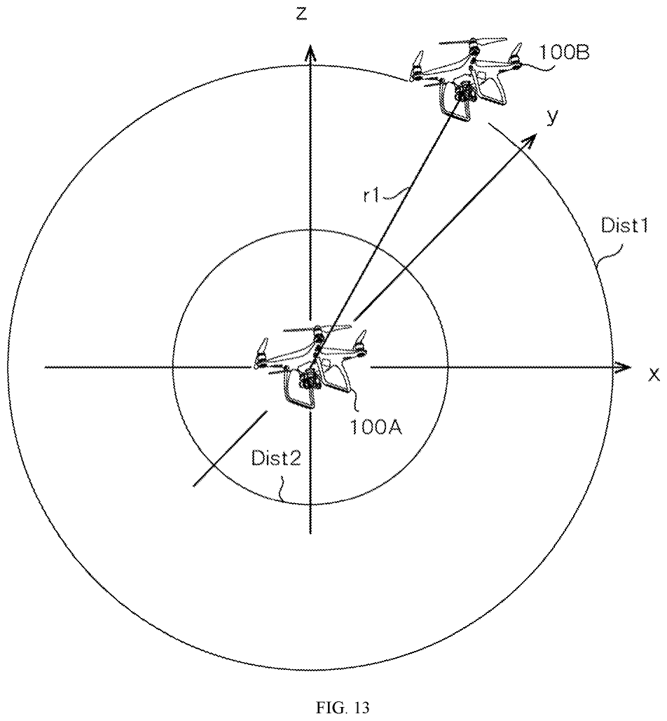

FIG. 13 is a spatial diagram showing threshold values Dist1 and Dist2 set for the distance r1 between two UAVs 100A and 100B.

Take the position of the UAV 100A as an origin point, the distance r1 between the two UAVs 100A and 100B can be determined by Formula (1) using the position coordinate (x, y, z) of the UAV 100B.

r1=(x²+y²+z²)^{1/2} (1)

The threshold value Dist1 used for comparing with the distance r1 from the other UAV 100B is a value at which a speed reduction is recommended when becoming close to the other UAV 100B is expected. The threshold value Dist2 used for comparing with the distance r1 from the other UAV 100B is a value at which a temporary stop such as hovering is recommended when a collision with another UAV 100B is expected. Therefore, the threshold Dist2 is a value less than the threshold Dist1.

When the distance r1 is not less than or equal to the threshold value Dist1, that is, when the distance r1 is greater than the threshold value Dist1, the server controller 310 of the server 300 returns to process T6 of the server 300 from process T8A as shown in FIG. 12A.

In some embodiments, when the distance r1 is less than or equal to the threshold value Dist1, the server controller 310 determines whether the distance r1 from the UAV 100B is less than or equal to the threshold value Dist2 at process T9A as shown in FIG. 12B.

When the distance r1 is not less than or equal to the threshold Dist2, that is, when the distance r1 is greater than the threshold Dist1, the server controller 310 recommends a low-speed flight mode, and generates recommendation information for recommending the low-speed flight mode at process T10A. In some embodiments, when the distance r1 is less than or equal to the threshold Dist2 at process T9A, the server controller 310 recommends a temporary stop such as hovering (a temporary stop mode), and generates recommendation information for recommending a temporary stop at process T11A.

At T12A, the server controller 310 transmits the recommendation information from process T10A or process T11A via the communication circuit 320 to the terminal 80A that instructs the control of the flight of the UAV 100A.

At T13A, the terminal controller 81 of the terminal 80A receives recommendation information from the server 300 via the communication circuit 85. At T14A, the terminal controller 81 displays a recommendation image containing the recommendation information on the display 88 based on the recommendation information.

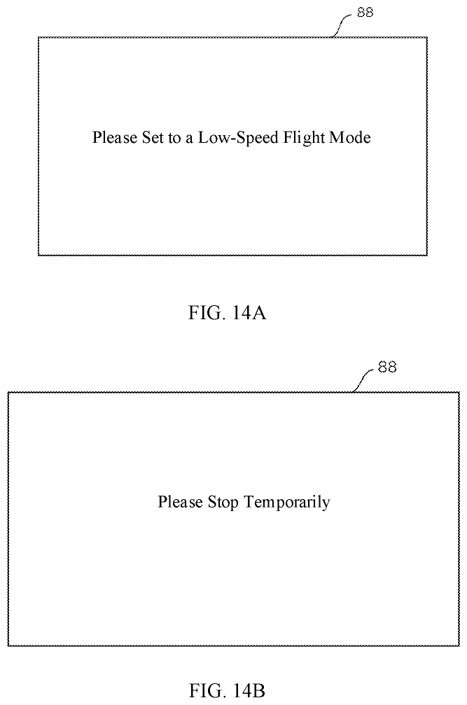

FIG. 14A is a diagram showing a recommendation image GM1 displayed on the display 88 when the distance r1 is within the threshold Dist1. For example, a message “Please set to a low-speed flight mode” is displayed at the recommendation image GM1. FIG. 14B is a diagram showing a recommendation image GM2 displayed on the display 88 when the distance r1 is within the threshold Dist2. For example, a message of “Please stop temporarily” is displayed at the recommendation image GM2. The messages shown in FIGS. 14A and 14B are displayed at the recommendation images GM1 and GM2 respectively. In some embodiments, these messages may be displayed superimposed on the shot image, or may be displayed superimposed on the shot image together with the marks shown in the other embodiments.

According to the processes shown in FIGS. 12A and 12B, when UAVs 100 are close to each other to some extent, the server 300 can prompt a warning message to the terminal 80 that instructs the control of the fight of the UAV 100 to limit the flight speed. Therefore, even when the UAVs 100 are close to each other, the terminal 80 can improve the flight safety of the UAVs 100 and cause the UAVs 100 to perform FPV flights. In some embodiments, when the UAVs 100 are closer to each other, further warning information can be prompted to limit the speed. For example, each UAV 100 may hover. Therefore, the server 300 can change the importance of the warning step by step according to the proximity of the UAVs 100 to each other, and simultaneously prompt information. Therefore, the user of each terminal 80 can recognize the approach of other UAVs 100 other than the UAV 100 operated by the user when performing a FPV flight toward the common point of interest, and take necessary measures according to the prompt information to operate the UAV 100.

In the above-described embodiments, when approaching another UAV 100B is expected, the terminal 80A displays a recommendation image. The server controller 310 may substitute for the instruction displayed at the recommendation image, or together with the instruction displayed at the recommendation image, perform instructions of the flight control such as a low-speed flight mode or a temporary stop (hovering, etc.) to the UAV 100A.

In this way, when a plurality of UAVs (for example, the UAV 100A, the UAV 100B) are approaching each other, the low-speed flight mode is recommended. In some embodiments, when there is a high possibility of a collision between the plurality of UAVs, a temporary stop such as hovering is recommended. Therefore, collisions between the UAVs 100 can be avoided.

In some embodiments, when the distance r1 from the UAV 100A to the UAV 100B is less than or equal to the threshold value Dist1, the server controller 310 may cause the terminal 80A to display information that recommends to limit the flight speed of the UAV 100A (for example, recommended information for setting to a low-speed flight mode). In this scenario, the displayed instruction information can be sent to the terminal 80A.

Therefore, the user U1 can be aware that the speed limit of the flight of the UAV 100A is recommended through the displaying of the recommendation information by the terminal 80A. The terminal 80A performs speed setting for limiting the flight, and can cause the UAV 100A to fly. The setting of the speed limit may be set automatically by the terminal controller 81 based on the recommended information, or manually via the operation unit 83. By limiting the speed, it is easier for the user U1 to confirm the state of the UAV 100A on the screen of the terminal 80A compared to a flight with a high speed, and it is possible to suppress the collision with the UAV 100B.

In some embodiments, the server controller 310 may cause the terminal 80A to display recommendation information that the shorter the distance r1, the more the speed of the UAV 100A is restricted to a low speed (for example, recommendation information for a temporary stop). In this scenario, the displayed instruction information can be sent to the terminal 80A.

Therefore, the shorter the distance r1, the higher the probability of a collision even with a relatively short travel distance. However, the shorter the distance r1, the lower is the speed that the server 300 can cause the UAV 100A to fly at. As such, the time needed to move to the position of the UAV 100B can be extended and collision can be more easily avoided.

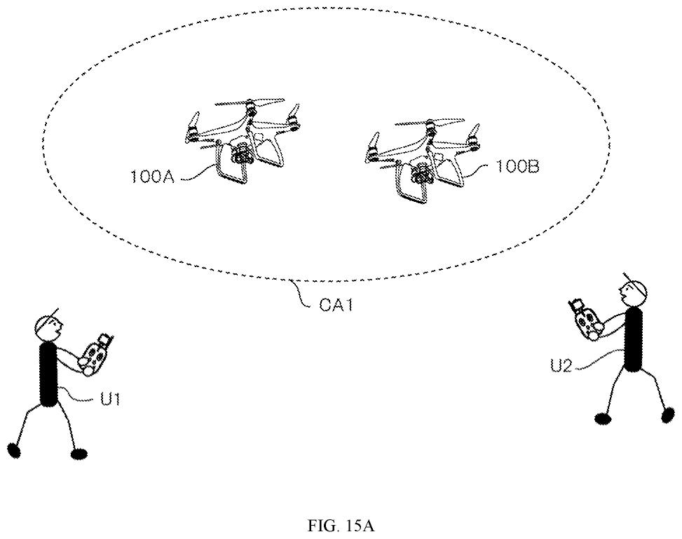

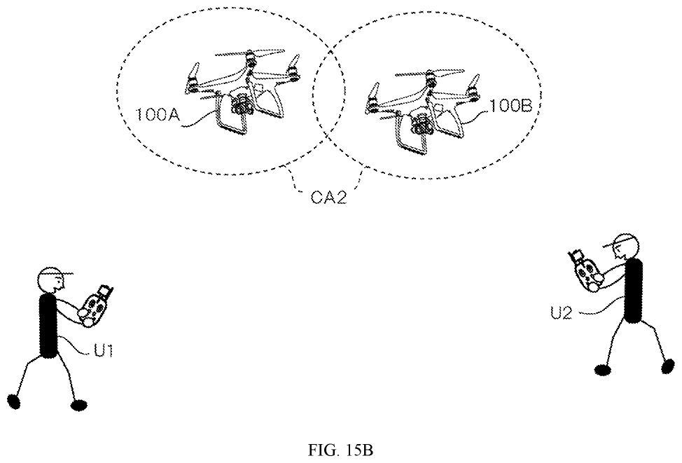

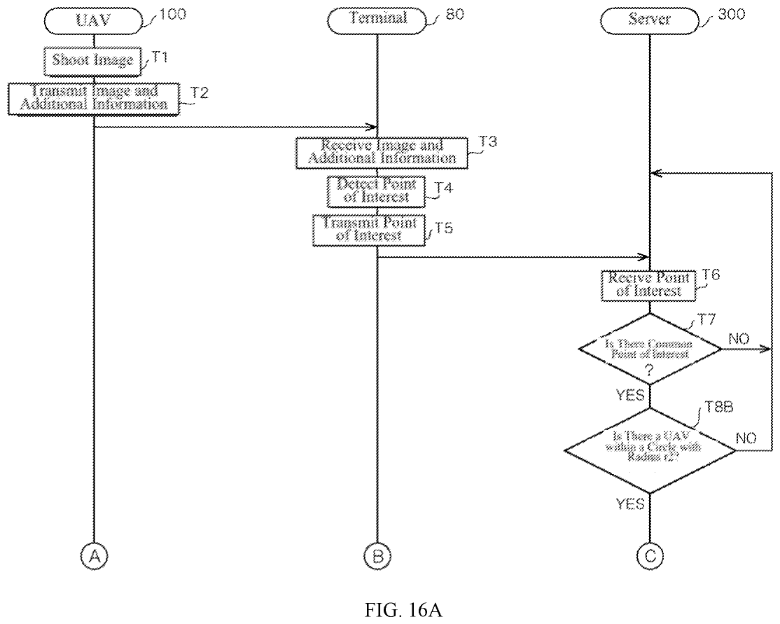

FIG. 15A is a diagram showing a scenario where the UAVs are operated with a visual observation. When two users U1 and U2 operate the UAVs 100A and 100B visually and respectively, a visual field CA1 of the users U1 and U2 is relatively wide. Therefore, it is easy for the users U1 and U2 to avoid the situation where the UAVs approach each other. Therefore, it is unlikely that the UAVs collide with each other.

FIG. 15B is a diagram showing a situation where the UAVs are operated in the FPV flight mode according to the present embodiments. When the two users U1 and U2 operate the UAVs 100A and 100B while observing the display 88 of the terminal 80, a visual field CA2 of the users U1 and U2 is narrowed. Even if other UAVs are flying near the UAVs operated by the users U1 and U2, it is difficult for the users U1 and U2 to recognize. Therefore, it is easy for UAVs to collide with each other.

In some embodiments, the server 300 can predominantly perform prompting information based on the point of interest of the user of each terminal 80. That is, the server controller 310 can obtain the point of interest tp1 from the terminal 80A and the point of interest tp2 from the terminal 80B via the communication circuit 320. The server controller 310 may send information to be displayed at the terminal 80A (for example, information related to the UAV 100B, recommendation information) to the terminal 80A via the communication circuit 320.

In this way, the server 300 can perform centralized processing on the information of the points of interest detected by the plurality of terminals 80 of the flight system 10 and instruct prompting information. Therefore, the server 300 can reduce the processing load of the terminal 80 involved in the processing of prompting information according to the common interest points.

In some embodiments, in the process T10 as shown in FIG. 7 and the process T14A as shown in FIG. 12B, the server controller 310 of the server 300 not only transmits information related to other UAV 100 and recommendation information to the terminal 80, but also instructs the UAV 100 in control corresponding to the recommended information. In this scenario, the server controller 310 may send flight control information such as a low-speed flight mode and a temporary stop to the terminal 80 via the communication circuit 320. When the terminal controller 81 of the terminal 80 receives the flight control information via the communication circuit 85, it can instruct to control the flight of the UAV 100 according to the flight control information.

For example, when the distance r1 between the UAV 100A and the UAV 100B is less than or equal to the threshold value Dist1, the server controller 310 may limit the flight speed of the UAV 100A. The restriction instruction information may be directly sent to UAV 100A, or may be sent via the terminal 80A.

Thus, the server 300 can limit the speed of the UAV 100A based on the positional relationship between the UAV 100A and the UAV 100B by instructing to limit the flight speed of the UAV 100A. In this scenario, even when the user U1 operates the terminal 80A without noticing the presence of the UAV 100B, it is possible to prevent the UAV 100A from flying at high speeds in accordance with the instructions from the terminal 80A, and thereby preventing the collision with the UAV 100B.

For example, the shorter the distance r1, the more the server controller 310 can limit the flight speed of the UAV 100A to a low speed. The restriction instruction information may be directly sent to the UAV 100A, or may be sent via the terminal 80A. In this scenario, the closer the UAV 100A is to the UAV 100B, the lower the flight speed. Therefore, although the closer the UAV 100A and the UAV 100B are, the more likely it is to collide, since the flight speed is also limited to a low level, the server 300 can prevent the collision with the UAV 100B.

In the above-described embodiments, a plurality of UAVs 100 approach each other. In some other embodiments, the UAVs 100 approach a destination that is a common point of interest.

The configuration of the flight system 10 in the following embodiments has substantially the same configuration as that of the embodiments described above. For the same elements as those in the above embodiments, the same symbols are used to omit or simplify the description.

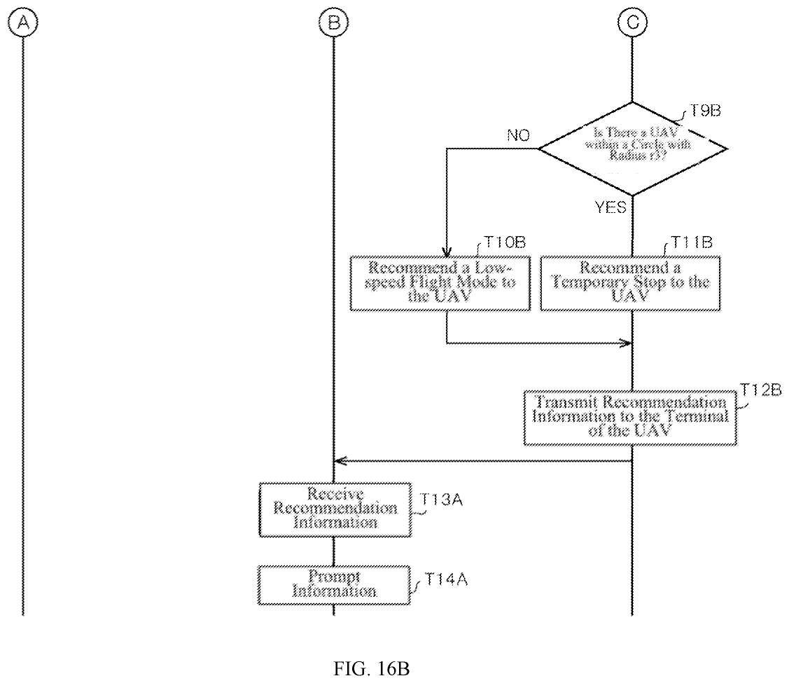

FIGS. 16A and 16B are sequence diagrams showing an instruction process for prompting information from a viewpoint of a destination performed by the server according to an embodiment. For the same processes as shown in FIGS. 7 and 12, by using the same symbols, the description thereof is omitted or simplified.

First, the flight system 10 executes processes from T1 to T6.

When there are a plurality of UAVs 100 having a same common point of interest at process T7, the server controller 310 of the server 300 determines whether there exists a UAV 100 within a circle with a radius of r2 and a center point of the common point of interest at process T8B. The radius r2 is a value at which a speed reduction is recommended when the UAV 100 is expected to approach the common point of interest.

In some embodiments, the location information of the common point of interest can be obtained from the map information stored in the storage 330 of the server 300. In some embodiments, the map information may be stored in an external map server, and the server controller 310 may obtain the map information via the communication circuit 320.

If there is no UAV 100 within the circle with the radius r2 and the center point of the common point of interest, the process returns to the initial process of the server controller 310 and the server 300.

In some embodiments, when there exists UAVs 100 within the circle with the radius r2 and the center point of the common point of interest, the server controller 310 determines whether there exists a UAV 100 within a circle with a radius r3 and a center point of the common point of interest at process T9B. The radius r3 is a value at which a temporary stop such as hovering is recommended when the UAV is expected to collide with the common point of interest. The radius r3 is less than the radius r2.

At T10B, when there is no UAV 100 within the circle with the radius of r3, the server controller 310 recommends to a terminal 80 corresponding to the corresponding UAV 100 (for example, a UAV located between a circle with a radius of r2 and a circle with a radius of r3) a low-speed flight mode.

In some embodiments, if there exists a UAV 100 within the circle with the radius r3, the server controller 310 recommends to the terminal 80 corresponding to the corresponding UAV 100 (for example, the UAV 100 located inside the circle with the radius r2) a temporary stop such as hovering at process T11B.

At T12B, the server controller 310 transmits the recommendation information of the process T10B or T11B to the terminal 80 corresponding to the corresponding UAV 100 via the communication circuit 320.

At T13A, the terminal controller 81 of the terminal 80 corresponding to the corresponding UAV 100 receives the recommendation information from the server 300 via the communication circuit 85. At T14A, the terminal controller 81 displays a recommendation image on the display 88 based on the recommendation information.

In this way, the server controller 310 of the server 300 can obtain the position information of the common point of interest. The server controller 310 can obtain the position information of the UAV 100. If the distance from the common point of interest to the UAV 100 is less than or equal to the radius r2, the server controller 310 can cause the terminal 80 to display information recommending to limit the flight speed of the UAV. In this scenario, the displayed instruction information can be sent to the terminal 80.

It is assumed that a plurality of UAVs 100 fly toward a destination that is a common point of interest. Therefore, when other UAVs 100 also approach the destination, the possibility of collision becomes high. Users can be aware that a speed limit of the flight is recommended through the displaying of the recommendation information by the terminal 80A. The terminal 80 performs speed setting for limiting the flight, and can cause the UAV 100 to fly. The setting of the speed limit may be set automatically by the terminal controller 81 based on the recommended information, or manually via the operation unit 83. By limiting the speed, it is easier for the user U to confirm the state of the UAV 100A on the screen of the terminal 80A compared to a flight with a high speed, and it is possible to suppress the collision with other UAVs 100.

In some embodiments, the server controller 310 may cause the terminal 80 to display the following recommendation information: the shorter the distance from the common point of interest to the UAV 100, the more the speed of the UAV 100 is restricted to a low speed. In this scenario, the displayed instruction information can be sent to the terminal 80.

The shorter the distance from the common point of interest to the UAV 100, the higher the probability of a collision even with a relatively short travel distance. In this scenario, the shorter the distance from the common point of interest to the UAV 100, the lower is the speed that the server 300 can cause the UAV 100 to fly. Therefore, the time needed to move to the common point of interest can be extended and collision can be more easily avoided.

In some embodiments, in the processes T10B and T11B, the server controller 310 of the server 300 not only transmits recommendation information to the terminal 80, but also instructs the UAV 100 of control corresponding to the recommended information. In this scenario, the server controller 310 may send flight control information such as a low-speed flight mode and a temporary stop to the terminal 80 via the communication circuit 320. When the terminal controller 81 of the terminal 80 receives the flight control information via the communication circuit 85, it can instruct to control the flight of the UAV 100 according to the flight control information.

For example, when the distance between the common point of interest and the UAV 100A is less than or equal to the radius r2, the server controller 310 may limit the flight speed of the UAV 100A. The restriction instruction information may be directly sent to UAV 100A, or may be sent via the terminal 80A.

Thus, the server 300 can limit the speed of the UAV 100A based on the positional relationship between the UAV 100A and the common point of interest by instructing to limit the flight speed of the UAV 100A. In this scenario, even when the user U1 operates the terminal 80A without noticing the presence of the common point of interest, it is possible to prevent the UAV 100A from flying at high speeds in accordance with the instructions from the terminal 80A, and thereby preventing the collision with objects existing at the common point of interest (destination) and other UAVs 100B approaching the common point of interest.

For example, the shorter the distance r1 between the common point of interest and the UAV 100A, the more the server controller 310 can limit the flight speed of the UAV 100A to a low speed. The restriction instruction information may be directly sent to the UAV 100A, or may be sent via the terminal 80A.

For example, the server controller 310 may perform control in a predetermined sequence so that the UAVs 100 sequentially approach the common point of interest when a plurality of UAVs 100 approach the destination as the common point of interest at the same time. The control information can be sent directly to the UAV 100A, or sent via the terminal 80A. In this way, the server 300 can avoid collisions between the UAVs 100 and cause each UAV 100 to reach the destination.

In the above-described embodiments, the server 300 instructs prompting information for avoiding the collision of the UAVs 100. In the following embodiments, any one terminal 80P of a plurality of terminals 80 instruct prompting information for avoiding a collision of the UAV 100.

The configuration of the flight system 10 in the following embodiments has substantially the same configuration as that of the embodiments described above. For the same elements as those in the above embodiments, the same symbols are used to omit or simplify the description.

In some embodiments, the terminal controller 81 of the terminal 80P performs processing related to an information prompting instruction of the server 300 for avoiding the collision of the UAV 100. The terminal controller 81 prompts information based on the user's point of interest in an image shot by the UAV 100. That is, the terminal controller 81 can perform the same processing as the processing performed by the server controller 310 of the server 300 in the above-described embodiments. The terminal controller 81 is an example of a processing unit.

In the embodiments described below, the terminal 80 will be described mainly as the terminal 80P or another terminal 80Q. There may be multiple terminals 80Q. The terminal 80P instructs a control of a flight of a UAV 100P, which is operated by a user Up. In addition, the terminal 80Q instructs a control of a flight of a UAV 100Q, which is operated by a user Uq. The terminal 80P may be the terminal 80A. The terminal 80Q may be the terminal 80B. The UAV 100P may be the UAV 100A. The UAV 100Q may be the UAV 100B. In addition, the terminal 80P and other terminals 80Q that perform information prompting instructions based on the common point of interest may be connected via a communication link to communicate in advance.

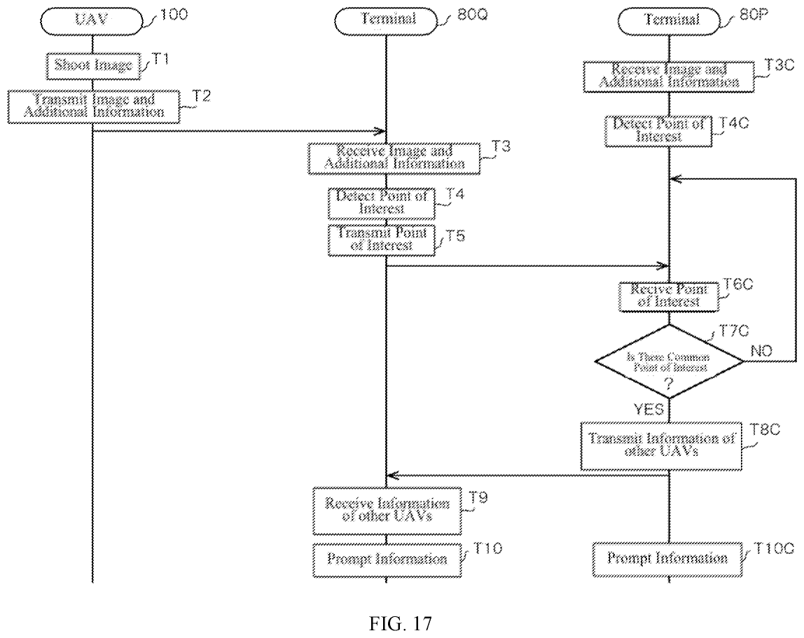

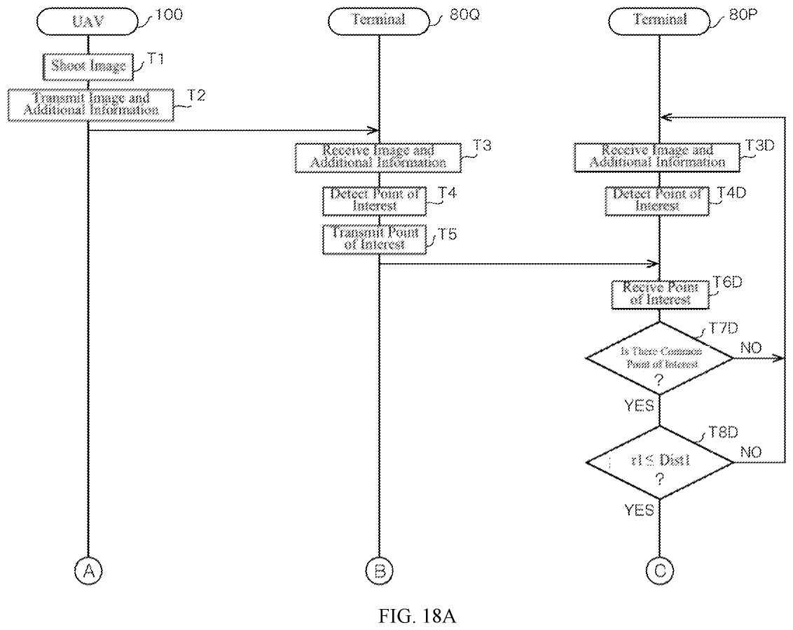

FIG. 17 is a sequence diagram showing an instruction process for prompting information from the viewpoint of the UAV performed by the terminal 80 according to an embodiment. For the same processes shown in FIG. 7 in the above-described embodiments, by using the same symbols, the description thereof is omitted or simplified.

Further, among the plurality of terminals 80, a terminal that performs the same operations as the operations of the server in the above-described embodiments is taken as the designated terminal 80P. The terminal 80P is an example of an information processing device.

First, the flight system 10 executes processes from T1 to T5.

Similar to the above-described embodiments with the UAV 100 and the terminal 80, in the embodiments with the UAV 100P, the photographing device 220 of the UAV 100P repeatedly shoots. The UAV controller 110 may store the shot image shot by the photographing device 220 in the memory 160, and also store additional information related to the shot image in the memory 160. The UAV controller 110 transmits the shot image and its additional information stored in the memory 160 to the terminal 80P via the communication interface 150.

At T3C, the terminal controller 81 of the terminal 80P receives the shot image and its additional information transmitted from the UAV 100P via the communication circuit 85. At T4C, the terminal controller 81 detects the point of interest of the user Up who operates the terminal 80P, and stores it in the memory 87. Further, the terminal controller 81 receives information including the point of interest transmitted from the other terminal 80Q via the communication circuit 85, and stores it in the memory 87 at process T6C. Therefore, the terminal 80P detects and obtains the points of interest of the user Up operating the terminal 80P of the local aircraft, and obtains the points of interest of the user Uq operating the other terminal 80Q from the other terminal 80Q.

At T7C, the terminal controller 81 determines whether there is information of a plurality of common points of interest among information of the plurality of points of interest stored in the memory 87. If there is no information of multiple common points of interest, the terminal controller 81 returns to the first process T3C of the terminal 80P.

In some embodiments, if there is information of the plurality of common points of interest at process T7C, the terminal controller 81 transmits information of other UAVs 100 (for example, the UAV 100P) via the communication circuit 85 to the terminal 80Q that has transmitted the information of the common points of interest at process T8C. Thereby, the terminal 80Q that has transmitted the information of the common points of interest can receive the instruction for prompting information from the terminal 80P, and superimpose a mark indicating the presence of another UAV 100P on the shot image displayed on the display 88 as a superimposed image.

In some embodiments, when there are a local terminal (terminal 80P) and other terminals 80Q that have transmitted information of the common point of interest, the terminal controller 81 of the terminal 80P superimposes a mark indicating the presence of another UAV 100Q on the shot image displayed on the display 88 according to information of another UAV 100Q about that the terminal 80Q instructs the control of the flight.

In this way, in some embodiments, when there are a UAV 100P (local aircraft) operated by the user Up who pays attention to the common point of interest, and the other UAV 100Q, even if the other UAV 100Q is not displayed on the shot image displayed at the display 88 of the terminal 80P, a mark indicating another UAV 100Q is also displayed. As a result, the user Up is able to learn the presence of the other UAV 100Q corresponding to the user Uq, and the user Uq and the user Up share a common point of interest. Further, the terminal 80P performs instructions of prompting information based on the common point of interest, which can omit the installation of the server 300, simplify the structure of the flight system 10, and reduce costs.

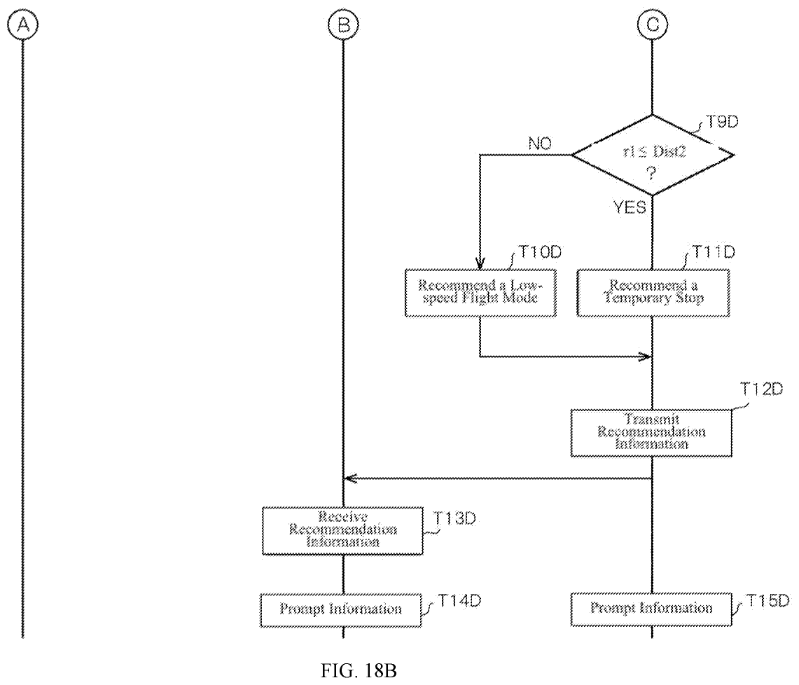

FIGS. 18A and 18B are sequence diagrams showing an instruction process for prompting information from the viewpoint of the UAV performed by the terminal 80 according to an embodiment. For the same processes as shown in FIGS. 12 and 17, by using the same symbols, the description thereof is omitted or simplified.

Further, among the plurality of terminals 80, a terminal that performs the same operations as the operations of the server 300 in the above-described embodiments is taken as a designated terminal 80P.

First, the flight system 10 performs processes from T1 to T5, T3D, T4D, and T6D. The process T3D is the same process T3C shown in FIG. 17. The process T4D is the same process T4C shown in FIG. 17. The process T6D is the same process T6C shown in FIG. 17.

At T7D, the terminal controller 81 of the terminal 80P determines whether or not there is information of a plurality of common points of interest among information of the plurality of points of interest stored in the memory 87. If there is no information of the plurality of common points of interest, the terminal controller 81 returns to the first process T3D of the terminal 80P.

In some embodiments, when there is information of the plurality common points of interest at the process T7D, the terminal controller 81 determines whether the distance r1 between the UAV 100P and the other UAV 100Q is less than or equal to the threshold value Dist1 at the process T8D.

When the distance r1 is greater than the threshold Dist1, the terminal controller 81 returns to the first process T3D of the terminal 80P.

In some embodiments, when the distance r1 is less than or equal to the threshold value Dist1, the terminal controller 81 determines whether the distance r1 is less than or equal to the threshold value Dist2 at the process T9D. When the distance r1 is greater than the threshold value Dist2, the terminal controller 81 recommends a low-speed flight mode, and generates recommendation information for recommending the low-speed flight mode at the process T10D. In some embodiments, when the distance r1 is less than or equal to the threshold Dist2 at the process T9D, the terminal controller 81 recommends a temporary stop such as hovering (temporary stop mode), and generates recommendation information for recommending the temporary stop at the process T11D.

At T12D, the terminal controller 81 transmits the recommendation information from the process T10D or T11D via the communication circuit 85 to another terminal 80Q that instructs the flight control of another UAV 100Q.

At T13D, the terminal controller 81 of the other terminal 80Q receives the recommendation information from the terminal 80P via the communication circuit 85. At T14D, based on the recommendation information, the terminal controller 81 displays a recommendation image containing the recommendation information on the display 88. Thereby, the other terminal 80Q that has received the instruction for prompting information based on the common point of interest can display the recommendation image on the display 88. Therefore, the user Uq of the other terminal 80Q can operate the other UAV 100Q with reference to the recommendation image, and thereby the safety of the operation is improved.

In some embodiments, when there exists another terminal 80Q that has transmitted information of the point of interest common to the local terminal (terminal 80P), the terminal controller 81 of the terminal 80P displays the recommendation image containing recommendation information on the display 88 at process T15D. Thereby, the terminal 80P that instructs prompting information based on the common point of interest can display the recommendation image on the display 88. Therefore, the user Up of the terminal 80P can operate the UAV 100P with reference to the recommendation image, and thereby the safety of the operation is improved.

In some embodiments, when a plurality of UAVs 100 (for example, the UAVs 100P, 100Q) approach each other, the low-speed flight mode is recommended. In some embodiments, when there is a high possibility of a collision between the plurality of UAVs 100, the temporary stop such as hovering is recommended. This helps to avoid collisions between the UAVs 100. Further, the installation of the server 300 can be omitted, the structure of the flight system 10 can be simplified, and the cost can be reduced.

In this way, the terminal controller 81 of the terminal 80P obtains the shot image GZ1 from the UAV 100P via the communication circuit 85. The terminal controller 81 detects the point of interest tp1 in the shot image GZ1. The terminal controller 81 obtains the point of interest tp2 from the other terminal 80Q via the communication circuit 85. The terminal controller 81 causes the display 88 to display information to be displayed on the terminal 80P (for example, information related to the other UAV 100Q and recommendation information).

Thereby, the terminal 80P can perform a series of processing from the detection of the point of interest to the determination of the common point of interest, and the display of information based on the determination of the common point of interest. Therefore, the terminal 80P does not need to separately install the server 300 that instructs information display based on the detection of the point of interest and the determination of the common point of interest. Therefore, the terminal 80P can simplify the structure for displaying information according to the detection of the common point of interest.

In some embodiments, a smartphone 80S is used as the terminal 80 to instruct the control of the flight of the UAV 100. In some embodiments, a head-mounted display (HMD) 500 is used as the terminal 80 to instruct the control of the flight of the UAV 100. Further, the flight system 10 of these embodiments has substantially the same structure as the above-described embodiments except that the terminal 80 is changed to the HMD 500. For the same elements, the same symbols are used to omit or simplify the description.

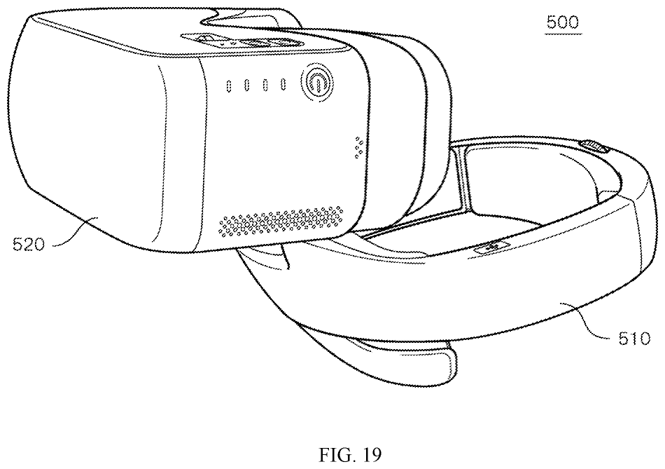

FIG. 19 is a perspective view of the HMD 500 according to some embodiments. The HMD 500 has a mounting member 510 for mounting at the user's head and a main body 520 supported by the mounting member 510.

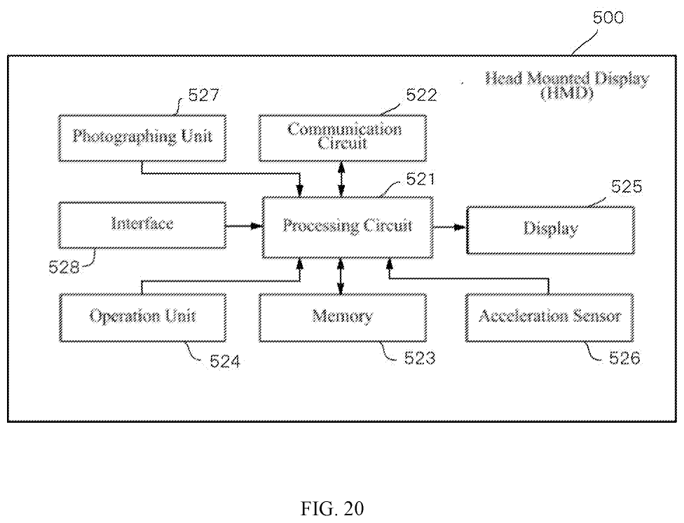

FIG. 20 is a block diagram showing a hardware configuration of the HMD 500. The HMD 500 includes a processing circuit 521, a communication circuit 522, a memory 523, an operation unit 524, a display 525, an acceleration sensor 526, a photographing unit 527, and an interface 528. These various structures of the HMD 500 may be provided at the main body 520.

The processing circuit 521 includes, for example, a processor, such as a CPU, an MPU, or a DSP. The processing circuit 521 performs signal processing for overall control of the operation of various units of the main body 520, processing of data input/output with other units, data arithmetic processing, and data storage processing.

The processing circuit 521 can obtain data and information from the UAV 100 via the communication circuit 522. The processing circuit 521 can also obtain data and information input through the operation unit 524. The processing circuit 521 may also obtain data and information stored in the memory 523. The processing circuit 521 may send data and information including a shot image of the UAV 100 to the display 525, and cause the display 525 to display information based on the data and information. The processing circuit 521 can execute an application program for instructing the control of the UAV 100. The processing circuit 521 can generate various data used in the application program.

The processing circuit 521 can perform a sight line detection based on an image of a user's eyes captured by the photographing unit 527, and can detect the point of interest in the same manner as in the above-described embodiments. Further, the processing circuit 521 may instruct the control of the flight of the UAV 100 based on a detection result of the sight line detection. That is, the processing circuit 521 can operate the UAV 100 in accordance with the movement of the sight line. For example, the processing circuit 521 may instruct the UAV 100 via the communication circuit 522 to cause the UAV 100 to fly toward a geographic location and an object corresponding to a position on the screen viewed by the user wearing the HMD 500. Therefore, the user's point of interest can become a destination of the UAV 100.

The processing circuit 521 can obtain information on an acceleration detected by the acceleration sensor 526 and instruct the control of the flight of the UAV 100 based on the acceleration. For example, the processing circuit 521 may instruct the UAV 100 via the communication circuit 522 to cause the UAV 100 to fly in a direction in which the head of the user wearing the HMD 500 is tilted.

The communication circuit 522 communicates with the UAV 100 through various wireless communication means. The wireless communication method may include a communication through wireless LAN, a Bluetooth®, a short-range wireless communication, or a public wireless network. Further, the communication circuit 522 may perform a wired communication.

The memory 523 may include a program that defines the operations of the HMD 500, a ROM that stores data of predetermined values, and a RAM that temporarily stores various information and data used when the processing circuit 521 performs processing. The memory 523 may be configured to be detachable from the HMD 500. Programs can include application programs.

The operation unit 524 receives data and information input by the user. The operation unit 524 may include buttons, keys, a touch screen, a touch panel, a microphone, or the like. The operation unit 524 can accept operations such as tracking and clicking to fly.

The display 525 can include a liquid crystal display (LCD), and displays various information and data output from the processing circuit 521. The display 525 can display the data of the shot image shot by the photographing device 220 of UAV 100.

The acceleration sensor 526 may be a three-axis acceleration sensor capable of detecting an attitude of the HMD 500. The acceleration sensor 526 may output detected attitude information as one of the operation information to the processing circuit 521.

The photographing unit 527 shoots various images. In order to detect a direction in which the user views, that is, the line of sight, the photographing unit 527 may shoot the eyes of the user and output to the processing circuit 521. The interface 528 can input and output information and data with an external device.

The HMD 500 can perform the same operations as shown in the above-described embodiments. Therefore, even if the terminal 80 is the HMD 500, the same effects as of the above-described embodiments can be obtained. Further, when the user wears the HMD 500, the visual field of the HMD 500 facing the outside is mainly blocked as compared to a scenario in which the user does not wear the HMD 500. Therefore, the user can visually confirm the image with an improved realism of the image and enjoy the flight control instructions of the FPV flight of the UAV 100. Further, the HMD 500 can cause the display 525 to display information and recommendation information of the other UAV 100 other than the UAV 100 that is instructed by the HMD 500 to perform flight control by receiving information prompt about whether there are common points of interest based on the points of interest detected by the processing circuit 521. Therefore, even if the visual field of the HMD 500 facing the outside is mainly blocked, the user wearing the HMD 500 can confirm the prompted information to improve the operation safety of the UAV 100 using the HMD 500.

In some embodiments, when the HMD 500 can instruct the flight control of the UAV 100 based on the acceleration detected by the acceleration sensor 526, it can instruct in the same manner as the flight control instruction of the UAV 100 that is operated using the left and right joysticks of the transmitter 50. Therefore, the flight system 10 may not include the transmitter 50.

In some embodiments, the HMD 500 may not instruct the flight control of the UAV 100 based on the acceleration detected by the acceleration sensor 526. In this scenario, the user can use the transmitter 50 to operate the UAV 100 while checking the display 525 of the HMD 500.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the technical scope of the present disclosure.

The execution order of the actions, sequences, steps, and stages of the devices, systems, programs, and methods shown in the claims, specification, and drawings of the disclosure, can be implemented in any order as long as there is no special indication such as “before . . . ,” “in advance,” etc., and the output of the previous processing is not used in the subsequent processing. Regarding the operation procedures in the claims, the specification, and the drawings of the disclosure, the description is made using “first,” “next,” etc., for convenience, but it does not mean that the operation must be implemented in this order.

### DESCRIPTION OF REFERENCE NUMERALS AND SYMBOLS

| | | | |
|---|---|---|---|
| 10 | Flight system | 50 | Transmitter |
| 50B | Casing | 53L | Left Joystick |
| 53R | Right Joystick | 61 | Transmitter |
| | | | Controller |
| 63 | Wireless | 65 | Interface |
| | Communication | | |
| | Circuit | | |
| 80, 80A, | Terminal | 81 | Terminal Controller |
| 80B | | | |
| 82 | Interface | 83 | Operation Unit |
| 85 | Communication | 87 | Memory |
| | Circuit | | |
| 88, 88A, | Display | 89 | Photographing |
| 88B | | | Unit |
| 100, 100A, | Unmanned Aerial | 102 | UAV Main Body |
| 100B | Vehicle (UAV) | | |
| 110 | UAV Controller | 150 | Communication |
| | | | Interface |
| 160 | Memory | 200 | Gimbal |
| 210 | Rotor Mechanism | 211 | Rotor |
| 212 | Drive Motor | 213 | Current Sensor |
| 220, 230 | Photographing | 240 | GPS Receiver |
| | Device | | |
| 250 | Inertial | 260 | Magnetic Compass |
| | Measurement Unit | | |
| 270 | Barometric | 280 | Ultrasonic Sensor |
| | Altimeter | | |
| 290 | Laser Measurement | 300 | Server |
| | Device | | |
| 310 | Server Controller | 320 | Communication |
| | | | Circuit |
| 330 | Storage | 340 | Memory |
| 500 | Head Mounted | 510 | Mounting Member |
| | Display | | |
| | (HMD) | | |
| 520 | Main Body | 521 | Processing Circuit |
| 522 | Communication | 523 | Memory |
| | Circuit | | |
| 524 | Operation Unit | 525 | Display |
| 526 | Acceleration | 527 | Photographing |
| | Sensor | | Unit |
| 528 | Interface | AN1, AN2 | Antenna |
| B1 | Power Button | B2 | RTH Button |
| CA1, CA2 | Visual field | Dist1, | Threshold |
| | | Dist2 | |
| GM1, GM2 | Recommendation | GZ1, GZ2 | Shot Image |
| | Image | | |
| J1 | Tower | J2 | Bridge |
| J3 | Building | mk1, mk2 | Mark |
| r1 | Distance | r2, r3 | Radius |
| tp1, tp2 | Point of Interest | U1, U2 | User |

What is claimed is:

1. An information processing device comprising:
a processor configured to:
obtain a first point of interest to which a first user pays attention in a first image, the first image being shot by a first flight body controlled by a first terminal operated by the first user;
obtain a second point of interest to which a second user pays attention in a second image, the second image being shot by a second flight body controlled by a second terminal operated by the second user;
determine whether the first point of interest and the second point of interest are a common point of interest; and
prompt information related to the second flight body to the first terminal in response to the first point of interest and the second point of interest being the common point of interest.

2. The information processing device of claim 1, wherein the processor is further configured to:
determine whether the first flight body is moving; and
in response to the first flight body being moving, prompt the information related to the second flight body to the first terminal.

3. The information processing device of claim 1, wherein the processor is further configured to:
obtain position information of the first flight body;
obtain position information of the second flight body; and
in response to a distance between the first flight body and the second flight body being less than or equal to a threshold, prompt the information related to the second flight body to the first terminal.

4. The information processing device of claim 1, wherein the processor is further configured to:
obtain position information of the first flight body;
obtain position information of the second flight body; and
prompt information indicating presence of the second flight body at a prompt position on a screen of the first terminal, the prompt position being determined based on a relative position of the second flight body relative to the first flight body.

5. The information processing device of claim 1, wherein the processor is further configured to:
obtain position information of the first flight body;
obtain position information of the second flight body; and
in response to a distance between the first flight body and the second flight body being less than or equal to a threshold, prompt recommendation information to the first terminal to recommend limiting a flight speed of the first flight body.

6. The information processing device of claim 5, wherein the recommendation information includes a recommendation to limit the flight speed of the first flight body to be positively related to the distance between the first flight body and the second flight body.

7. The information processing device of claim 1, wherein the processor is further configured to:
obtain position information of the common point of interest;
obtain position information of the first flight body; and
in response to a distance between the common point of interest and the first flight body being less than or equal to a threshold, prompt recommendation information to the first terminal to recommend limiting a flight speed of the first flight body.

8. The information processing device of claim 7, wherein the recommendation information includes a recommendation to limit the flight speed of the first flight body to be positively related to the distance between the common point of interest and the first flight body.

9. The information processing device of claim 1, further comprising:
a communication circuit; and
the processor is further configured to:
obtain the first point of interest from the first terminal via the communication circuit;
obtain the second point of interest from the second terminal via the communication circuit; and
transmit the information related to the second flight body to the first terminal via the communication circuit.

10. The information processing device of claim 1, further comprising:
a communication circuit; and
a prompt device; and
the processor is further configured to:
obtain the first image from the first flight body via the communication circuit;
detect the first point of interest in the first image;
obtain the second point of interest from the second terminal via the communication circuit; and
control the prompt device to prompt the information related to the second flight body.

11. An information prompt method comprising:
obtaining a first point of interest to which a first user pays attention in a first image, the first image being shot by a first flight body controlled by a first terminal operated by the first user;
obtaining a second point of interest to which a second user pays attention in a second image, the second image being shot by a second flight body controlled by a second terminal operated by the second user;
determining whether the first point of interest and the second point of interest are a common point of interest; and
prompting information related to the second flight body to the first terminal in response to the first point of interest and the second point of interest being the common point of interest.

12. The method of claim 11, further comprising:
determining whether the first flight body is moving;
wherein prompting the information related to the second flight body includes prompting the information related to the second flight body to the first terminal further in response to the first flight body being moving.

13. The method of claim 11, further comprising:
obtaining position information of the first flight body;
obtaining position information of the second flight body; and
wherein prompting the information related to the second flight body includes prompting the information related to the second flight body to the first terminal further in response to a distance between the first flight body and the second flight body being less than or equal to a threshold.

14. The method of claim 11, further comprising:
obtaining position information of the first flight body;
obtaining position information of the second flight body; and
wherein prompting the information related to the second flight body includes prompting information indicating presence of the second flight body at a prompt position on a screen of the first terminal, the prompt position being determined based on a relative position of the second flight body relative to the first flight body.

15. The method of claim 11, further comprising:
obtaining position information of the first flight body;
obtaining position information of the second flight body; and
in response to a distance between the first flight body and the second flight body being less than or equal to a threshold, prompting recommendation information to the first terminal to recommend limiting a flight speed of the first flight body.

16. The method of claim 15, wherein the recommendation information includes a recommendation to limit the flight speed of the first flight body to be positively related to the distance between the first flight body and the second flight body.

17. The method of claim 11, further comprising:
obtaining position information of the common point of interest;
obtaining position information of the first flight body; and
in response to a distance between the common point of interest and the first flight body being less than or equal to a threshold, prompting recommendation information to the first terminal to recommend limiting a flight speed of the first flight body.

18. The instruction method for prompting information of claim 17, wherein the recommendation information includes a recommendation to limit the flight speed of the first flight body to be positively related to the distance between the common point of interest and the first flight body.

19. The method of claim 11, wherein:
obtaining the first point of interest includes obtaining the first point of interest from the first terminal;
obtaining the second point of interest includes obtaining the second point of interest from the second terminal; and
prompting the information related to the second flight body includes transmitting the information related to the second flight body to the first terminal.

20. A non-transitory computer-readable recording medium storing a program that, when executed by a processor, causes the processor to:
obtain a first point of interest to which a first user pays attention in a first image, the first image being shot by a first flight body controlled by a first terminal operated by the first user;
obtain a second point of interest to which a second user pays attention in a second image, the second image being shot by a second flight body controlled by a second terminal operated by the second user;
determine whether the first point of interest and the second point of interest are a common point of interest; and
prompt information related to the second flight body to the first terminal in response to the first point of interest and the second point of interest being the common point of interest.
